(19) United States
(12) Patent Application Publication
(10) Pub. No.: US 2009/0140946 A1
(43) Pub. Date: Jun. 4, 2009

(54) EFFICIENT METAMATERIAL-INSPIRED ELECTRICALLY-SMALL ANTENNA

(76) Inventors: Richard W. Ziolkowski, Tucson, AZ (US); Aycan Erentok, Ulm (DE)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/262,678

(22) Filed: Oct. 31, 2008

Related U.S. Application Data
(60) Provisional application No. 61/001,230, filed on Oct. 31, 2007.
(60) Provisional application No. 61/008,783, filed on Dec. 21, 2007.

(51) Int. Cl. H01Q 7/08; H01Q 9/16; H01Q 15/08; H01Q 1/50

(52) U.S. Cl. 343/788; 343/822; 343/911 R; 343/860

(57) ABSTRACT

Planar (two-dimensional) and volumetric (three-dimensional), metamaterial-inspired, efficient electrically-small antennas. The electric-based and magnetic-based antenna systems are shown to be naturally matched to a source and are linearly scalable to a wide range of frequencies. The systems include a radiating element that is fed by the source through a finite ground plane via a feedline and an electrically-small, one-unit cell made of a metamaterial that is adapted to match the input impedance of the antenna.

### CROSS REFERENCE TO RELATED APPLICATIONS

The present invention claims a right of priority to U.S. provisional patent application 61/001,230 filed on Oct. 31, 2007 entitled “An Efficient Metamaterial-inspired Electrically-Small Antenna” and U.S. provisional patent application 61/008,783 filed on Dec. 11, 2007 entitled “Metamaterial-Inspired Efficient Electrically-Small Antenna: Two-Dimensional Realizations”.

### STATEMENT REGARDING FEDERALLY SPONSORED RESEARCH OR DEVELOPMENT

The United States Government has a paid-up license in this invention and the right in limited circumstances to require the patent owner to license others on reasonable terms as provided for by the terms of Contract HR0011-05-C-0068 awarded by the Defense Advanced Research Projects Agency (DARPA).

### BACKGROUND OF THE INVENTION

The present invention relates to the field of electrically-small antenna system for use in wireless applications such as for a global positioning system and, more specifically, to the design of an electrically-small antenna system that is inspired by metamaterials.

Recent technological advances in wireless communications and sensor networks have changed the expectations of antenna designs and their performance. For example, the size reduction of state-of-the-art electronics circuits has led to several wireless applications that have conflicting requirements for their antenna systems. In particular, they have exposed the need for electrically-small antennas that are efficient and that have significant bandwidths.

These requirements, however, are contradictory when standard electrically-small antenna designs are considered. Indeed, such radiators are known to be inefficient because they have large reactances (imaginary impedance) and small resistances (real impedances reflecting coupling to free space) and, as a result, are very poorly matched to a given source.

The design of reactance and resistive matching networks is a challenging task that often introduces additional constraints on the overall performance of the resulting system. For example, one common matching network, such as the electrically small electric dipole antenna system 90 shown in FIG. 1, includes a source 92, a quarter-wavelength transformer 94, and an inductive element 96. The approach taken by the electric dipole antenna system 90 includes adapting the quarter-wavelength transformer 94 to match the low input resistance to the resistance of the source 92, and adapting the inductive element 96 to produce a total input reactance of zero, e.g., by introducing the appropriate conjugate reactance. Unfortunately, the total system 90 requires a radiating element, e.g., a dipole, 91 and 93 and a matching circuit 94 and 96, which is not necessarily “electrically-small”.

An efficient electrically-small antenna (EESA) is shown in FIG. 2. The EESA system 95 includes a source 92, and a metamaterial-based matching element 99 and a modified radiating element 97 and 98, which are contained within a sphere of radius a, which is smaller than a radiansphere. Numerous other matching network approaches have also been considered for EESAs. However, they rely on various combinations of matching circuit and radiating components, which include benefits and drawbacks.

Accordingly, it would be desirable to provide an inexpensive, easy-to-build, efficient, electrically-small antenna system that is naturally matched to a source. Furthermore, it would be desirable to provide an electrically-small antenna system having a relatively high overall power efficiency; that can be scaled to a wide range of frequencies without compromising performance; and that can provide multi-frequency operation within a relatively small footprint.

### SUMMARY OF THE INVENTION

Planar (two-dimensional) and volumetric (three-dimensional), metamaterial-inspired, efficient electrically-small antennas are disclosed. The electric-based and magnetic-based antenna systems are shown to naturally match a source to free space and, furthermore, are linearly scalable to a wide range of frequencies.

The antenna systems include a radiating element, such as a loop antenna or monopole antenna, which is fed by the source through a finite ground plane and an electrically-small, one-unit cell made of a metamaterial. The metamaterial-inspired element is structured and arranged to match the reactance of the antenna, allowing the antenna to radiate efficiently.

According to the present invention, a unit cell, e.g., an atom, of an appropriate type of metamaterial can be introduced into the extreme near field of a radiator and whose characteristics can be tailored to best utilize the available electrically-small design volume to achieve matching of the input impedance of the combined radiator and unit cell to the course impedance, as well as producing a high radiation efficiency, and, thus, to realize a high overall efficiency of the resulting antenna system.

### BRIEF DESCRIPTION OF THE SEVERAL VIEWS OF THE DRAWINGS

The invention will be more fully understood by reference to the following Detailed Description of the invention in conjunction with the Drawings, of which:

FIG. 1 shows an electrically-small electric dipole antenna system in accordance with the prior art;

FIG. 2 shows an efficient, electrically-small antenna in accordance with the prior art;

FIG. 3 shows a perspective view of the three-dimensional, metamaterial-inspired, magnetic-based, electrically-small, EZ antenna system in accordance with the present invention;

FIG. 4 shows a cross-sectional view of the three-dimensional, metamaterial-inspired, magnetic-based, electrically-small, EZ antenna system in accordance with the present invention;

FIG. 5 shows a perspective view of the two-dimensional, magnetic-based, planar version of an EZ antenna in accordance with the present invention;

FIG. 6 shows a cross-sectional view of the two-dimensional, magnetic-based, planar version of an EZ antenna with an interdigitated capacitor in accordance with the present invention;

FIG. 7 shows a perspective view of the two-dimensional, magnetic-based, planar version of an EZ antenna with a lumped element capacitor in accordance with the present invention;

FIG. 8 shows a cross-sectional view of the two-dimensional, magnetic-based, planar version of an EZ antenna with a lumped element capacitor in accordance with the present invention;

FIG. 9 shows a perspective view of a three-dimensional, electric-based version of an EZ antenna in accordance with the present invention;

FIG. 10 shows a cross-sectional view of the three-dimensional, electric-based version of the EZ antenna of FIG. 9 in accordance with the present invention;

FIG. 11 shows a perspective view of the two-dimensional, electric-based version of an EZ antenna in accordance with the present invention;

FIG. 12 shows predicted complex input impedance values for Design 3 of Tables I, II, and III;

FIG. 13 shows comparative predicted (far-field) E-field and H-field patterns for Designs 2 and 3 of Tables I, II, and III;

FIG. 14 shows E-field and H-field vector plots for the electrically-small antenna system shown in FIG. 3;

FIG. 15 shows predicted magnitude values of the surface current vectors on the electrically-small antenna system shown in FIG. 3 for Design 3 at 1580 MHZ;

FIG. 16 shows predicted complex impedance values for Design 6 of Tables IV, V and VI;

FIG. 17 shows predicted far-field E-field and H-field patterns for Design 6 of Tables IV, V and VI;

FIG. 18 shows predicted complex input impedance values for Design 12 of Tables VII, VIII, and IX;

FIG. 19 shows predicted S₁₁ values for a 50-Ω source obtained for Design 12 of Tables VII, VIII, and IX;

FIG. 20 shows predicted far-field radiation patterns obtained for Design 14;

FIG. 21 shows predicted complex input impedance values for Design 17 of Tables X, XI, and XII;

FIG. 22 shows predicted far-field E-field and H-field patterns for Design 17 of Tables X, XI, and XII;

FIG. 23 shows simulated and measured S₁₁ values for a 50-Ω source obtained for the fabricated Design 6 antenna system;

FIG. 24 shows simulated and measured S₁₁ values for a 50-Ω source obtained for the fabricated Design 10 antenna system;

FIG. 25 shows simulated and measured S₁₁ values for the fabricated Design 17 antenna system;

FIG. 26 shows the measured total radiated power of the Design 17 2D electric-based EZ antenna at 1373 MHz; and

FIG. 27 shows the effect of ground plane finiteness on the performance of the Design 17 2D electric-based EZ antenna.

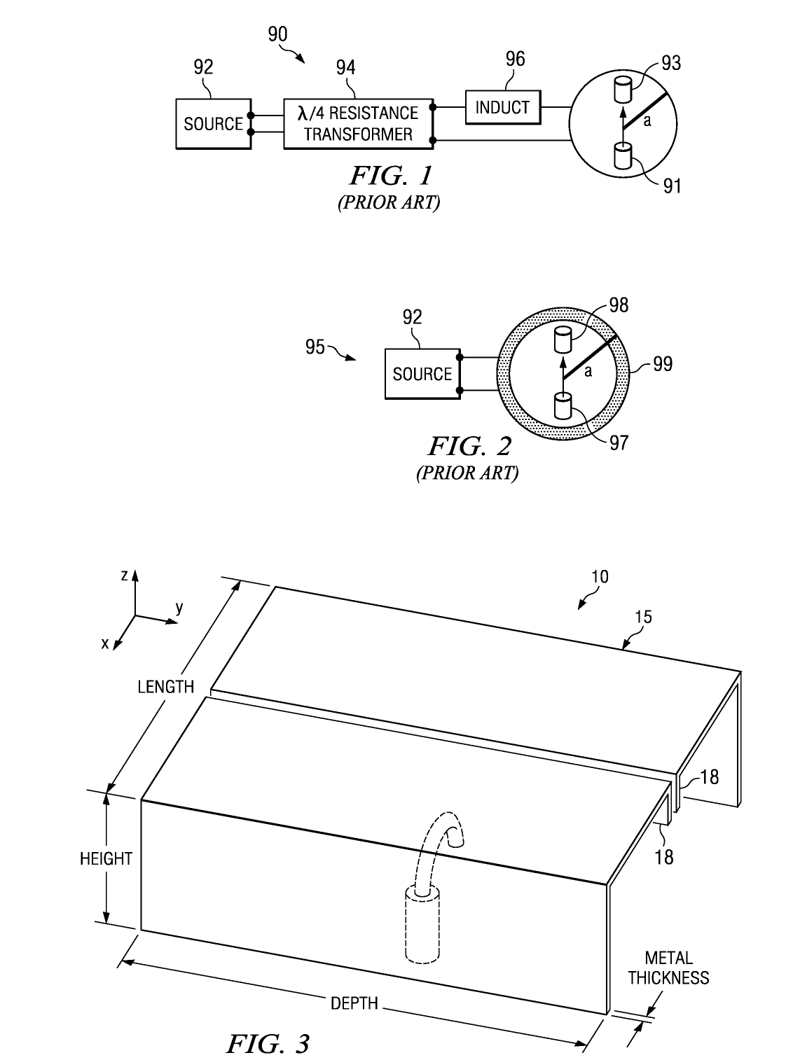

### DETAILED DESCRIPTION OF THE INVENTION

### The Metamaterial Paradigm

The introduction of so-called metamaterials and their exotic properties provides an alternate design approach that can lead to improved performance characteristics of several radiating and scattering systems. Metamaterials (MTMs) are artificial materials that are specially engineered to provide, inter alia, electromagnetic responses that are otherwise not readily available naturally. MTMs have led to improved performance characteristics of several radiating and scattering systems. Examples of use of MTMs include as artificial magnetic conductors (AMCs), as sub-wavelength resolution lenses, and as metamaterially-based, electrically-small antennae.

Analytical research by others into metamaterial-based efficient, electrically-small antennas (EESA) has been performed. By “metamaterial-based” it is meant that the performance of a bare electric or magnetic dipole radiating element is modified by surrounding the radiating element with a spherical shell that is an idealized homogeneous, isotropic, lossy, dispersive material. This prior research has revealed that it is possible to design an EESA system formed by an electrically-small dipole antenna radiating in the presence of either an idealized homogeneous and isotropic double-negative (DNG) spherical shell or an epsilon-negative (ENG) spherical shell. Indeed, it has been demonstrated that such antenna systems can be made resonant with a overall efficiencies close to unity (1) using idealized, loss-less metamaterial spherical shells.

For instance, the inductive nature of the ENG spherical shell can be used to compensate for the capacitive nature of the electrically-small dipole antenna, to form a resonant radiating system. In contrast with infinitesimal, dipole-driven canonical problems in which the radiating element is excited with a constant current, the input impedance can be calculated for the radiating elements in these metamaterial-based EESAs, e.g., a center-fed dipole or a coax-fed monopole assigned with finite conductivity, and driven using a voltage source or a current source, surrounded by an ENG spherical shell or by an ENG hemi-spherical shell. Consequently, the accepted power and overall efficiency of these metamaterial-based EESAs can be calculated for the lossy, metamaterial spherical shell driven by the antenna with a finite conductivity. Moreover, the metamaterial spherical shell can be designed to create a matched resonant antenna system, which is to say that the total input reactance is equal to zero or substantially zero and, further, that the total input resistance is equal to the resistance of the source, and which produces the best conversion to the wave impedance of free space.

The purpose of an antenna is to transform voltages and currents into electromagnetic waves on transmit and vice versa on receive. This is most efficiently performed if the antenna provides impedance matching between the transmitter source and the receiver load realized in electronic form. The term “meta material” is used to denote a medium used in the shell structure (defined in terms of location and impedance properties) that promotes this, resulting in an electrically-small environment. This invention presents procedures and structures that embody the achievement of that goal through the design process disclosed. Embodiments are presented of specific shell designs that accomplish this matching or near matching, but the invention covers other materials satisfying the metamaterial properties as disclosed herein.

Previously, MTM-based antenna systems have also been conceptualized to include structures that are made of ideal double negative (DNG) media and/or single negative (SNG) media. For example, an electrically-small, electric dipole antenna and a loop antenna radiating in the presence of an isotropic, homogeneous, loss-less and dispersive, electrically-small epsilon negative (ENG) spherical shell and a mu-negative (MNG) spherical shell, respectively, have been shown to produce a radiating element that is impedance matched to a specified source. Such a matching of impedance with a source having a predetermined frequency produces an efficient electrically-small antenna system. More specifically, the electrically-small ENG metamaterial spherical shell produces the necessary inductance for matching the impedance of the electric dipole antenna and the electrically-small MNG metamaterial spherical shell provides the necessary capacitance to match the impedance of the loop antenna, to produce electrically-small resonators that perform as efficient, electrically-small antenna systems.

The MTMs associated with these designs, however, require unit cells whose sizes are substantially sub-wavelength and that must be smaller than the radiating elements. To address these design requirements, three-dimensional application of MTM unit cell designs has inspired the present invention. Indeed, theoretical and numerical studies of the radiation and resonance behaviors of these metamaterial-based EESA systems, as well as efforts to conceptualize structures that might be used to build them, have led to the discovery of several realizable planar, i.e., two-dimensional (2D), and volumetric, i.e., three-dimensional (3D), metamaterial-inspired EESA systems. By “metamaterial-inspired” it is meant that resistive and reactance matching is achieved not with a metamaterial, i.e., a volumetric piece of this medium that can be formed in the shape of a spherical shell, but rather with an element such as used as an inclusion for use in a metamaterial unit cell design to realize an ENG, MNG or DNG media. Furthermore, if one of the elements described in greater detail below were placed in a slab unit cell scattering geometry and a material property extraction code is applied to the resulting S-parameters, the metamaterial-inspired element will exhibit the ENG, MNG, and/or DNG properties required for the corresponding metamaterial-based antenna system. In short, an ENG metamaterial element can be used with an electric dipole radiator or an MNG metamaterial element can be used with a magnetic dipole radiator to achieve the EESA system.

These metamaterial-inspired 2D, planar and 3D, volumetric EESA systems referred to as “EZ antenna systems” are easy to design; are easy and inexpensive to build; and are easy to test. In the subsections below, several 3D, and 2D, magnetic-based EZ antenna designs are implemented using MNG metamaterial-inspired structures, such as, respectively, an extruded 3D, capacitively-loaded loop element and planar, interdigitated or planar, lumped capacitive element elements, which are driven by an electrically-small circular loop or rectangular semi-loop antennae that are coaxially-fed through a finite perfect electric conductor (PEC) ground plane.

### Three-Dimensional Realization of a Magnetic Antenna System

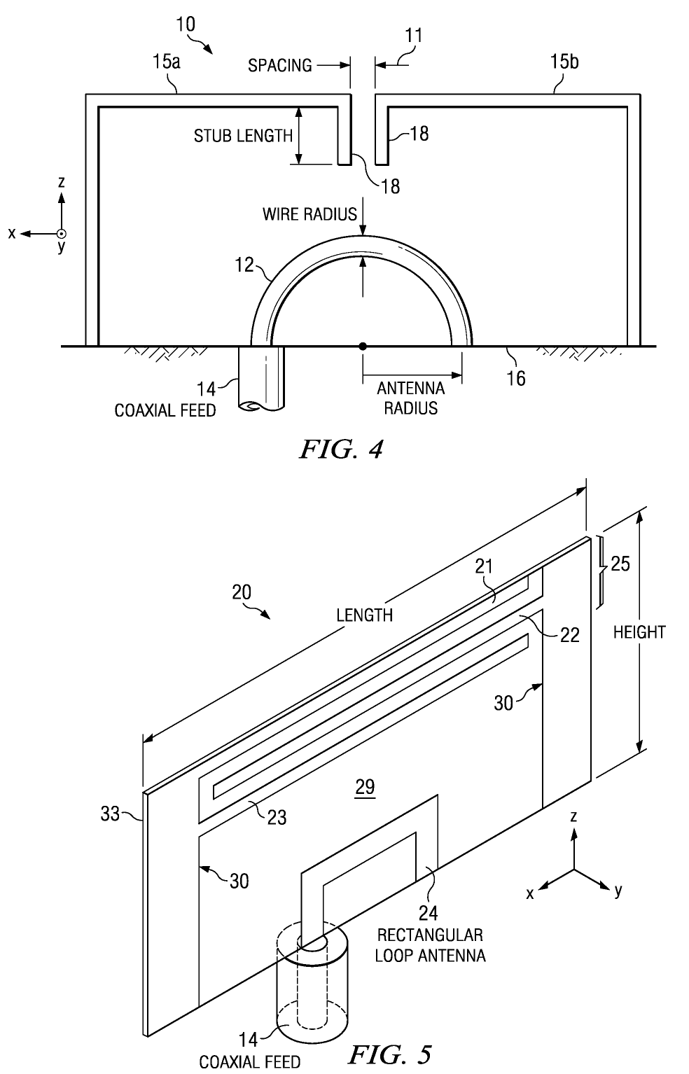

The MTM-inspired element of the present invention is a three-dimensional extrusion of a planar, capacitively loaded loop (CLL), such as has been previously used as a unit cell inclusion for realizing a volumetric, artificial magnetic conductor (AMC). Referring to FIG. 3 and FIG. 4, a magnetic-based antenna system 10 having an MTM-inspired, three-dimensional extrusion of a planar, CLL 15 is shown. The antenna system 10 is adapted to be resonantly driven by a semi-circular loop antenna 12 that can be matched naturally to the source (not shown). The loop antenna 12 has a predetermined wire length, wire diameter, and wire bend radius and is fed through a finite-sized, PEC ground plane 16 via a feedline 14, e.g., a 50-ohm (Ω) coaxial feedline. Advantageously, the antenna system 10 operates as a resonant, electrically-small magnetic dipole.

The antenna system 10 includes an extended CLL 15 that is structured and arranged to provide more capacitance. The extended surface of the CLL 15 provides an effective region that efficiently captures and resonantly magnifies the magnetic flux generated by the electrically-small, semi-circular loop antenna 12 that is driving it. The extended capacitive element 15 provides a larger capacitance, which allows the resulting CLL 15 to have a lower resonant frequency and enables finer tuning capability.

The embodied CLL 15 includes first and second CLL elements 15a and 15b, each having a length, a height, a depth, and a “J-sheet” cross-section. Each of the first and second CLL elements 15a and 15b includes a stub portion 18, which are separated by a capacitor gap 11 along the entire depth of the first and second CLL elements 15a and 15b.

In operation, the loop antenna 12 generates, in the presence of the CLL element 15, a resonantly-large magnetic flux that creates, i.e., induces, current on the surfaces of the extruded CLL elements 15a and 15b. The induced current causes a large charge separation between the two stubs 18, creating a voltage potential across the capacitor gap 11. The voltage potential across the capacitor gap 11 produces correspondingly large electric fields. The stored charge and the strong electric fields produced across the capacitor gap 11 provide a capacitance in the antenna system 10. The magnitude of the stored capacitance is sufficiently large to match both the inductance resulting from the current flow on the surface of the extruded CLL elements 15a and 15b and on the PEC ground plane 16, as well as the inductance of the electrically-small, semi-circular loop antenna 12. In short, the extruded electrically-small CLL 15 is a self-resonant reactive element that can be further matched to the reactance part of the electrically-small, semi-loop circular 12 to create a resonant, RLC tank circuit.

A non-exhaustive list of some of the parameters that impact the resonant behavior of the antenna system 10 include the bend radius of the loop antenna 12, the length, height, and depth of teach of the CLL elements 15a and 15b, the length of the stub 18, and the gap spacing 11 between the stubs 18. Assuming that the wire of the loop antenna 12 is electrically-thin, the bend radius of the semi-circular loop 12 will play a significant role in the ability to match the resistance of the radiating element to the feedline 14, to achieve a resonant behavior in the overall system 10. For example, increasing the bend radius of the semi-circular loop 12 enhances the resonant coupling of the driving loop antenna 12 to the radiating, extruded CLL 15. As a result, the radiation resistance of the antenna system 10 is also controlled and enhanced.

The length and height of the CLL 15 are structured and arranged to provide the primary inductance of the antenna system 10 while the depth of the CLL 15, the length of the stub 18, and the capacitor gap 11 between stubs 18 provide the primary capacitance of the antenna system 10. Although, the wire thickness of the loop antenna 12 and the metal thickness of the CLL 18 and stubs 18 contribute some to the inductance, their overall effect vis-à-vis the antenna system 10 as a whole is limited in relative terms. Those skilled in the art, however, can appreciate that the wire and metal thicknesses can significantly impact the conductor losses in the antenna system 10.

### Two-Dimensional Realizations of Magnetic Antenna Systems

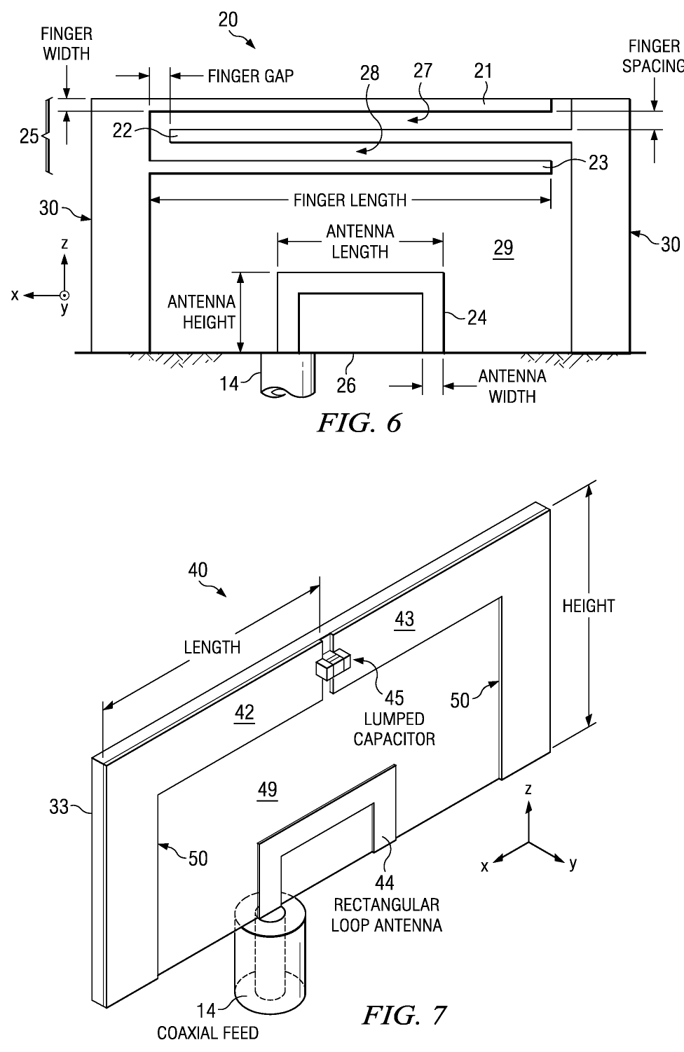

Two-dimensional (2D), magnetic-based, planar versions of EZ antennas are also disclosed. Referring to FIG. 5 and FIG. 6, a 2D, magnetic-based EZ antenna system 20 is shown. The design of the 2D antenna system 20 includes a dielectric laminate structure 31 such as Rogers 5880 Duroid™ having a 31 mils (0.787 mm) thick substrate and a 0.5 oz. (17 μm thick) electrodeposited copper. Use of a dielectric substrate 31, however, introduces dielectric losses, which further decrease the overall efficiency of the antenna system 20. Moreover, low-loss dielectric substrates 31 would increase the cost of the design. Notwithstanding, the dielectric-backed conductor leads to straightforward fabrication of the MTM-inspired structure. However, a planar, magnetic-based EZ antenna based on a metal-only structure would produce an optimal 2D design.

2D Realization Based on Planar Interdigitated Capacitors

A first 2D, planar version of the magnetic-based EZ antenna system 20 replaces the third dimension of the extruded CLL element 15 of the 3D version with a planar, interdigitated capacitor 25. The 3D, metamaterial-inspired, magnetic-based antenna system 20 includes a self-resonant, reactive planar, interdigitated CLL element 30 that can be matched to the reactance part of an electrically-small, rectangular, semi-loop antenna 24 that is coaxially-fed through a finite PEC ground plane 26.

The CLL element 30 includes an interdigitated capacitor 25 having a plurality of interdigitated capacitor fingers 21, 22, and 23. The number of capacitor fingers, finger length, horizontal gap between the free end of the capacitor finger and the substantially planar CLL element 30, and the vertical, capacitive gaps 27 and 28 between adjacent fingers 21 and 22 and fingers 22 and 23, respectively, provide a tuning capability of the resonant frequency. To reduce copper losses, system design should include a minimum number of fingers, to enhance overall efficiency.

The relatively long and closely spaced capacitor fingers 21, 22, and 23 can be used to obtain lower resonant frequencies. The region 29 between the bottom interdigitated capacitor finger 23 and the PEC ground plane 26 captures the magnetic flux generated by the electrically-small, rectangular semi-loop antenna 24 that is driving it.

The changes with time of this resonantly-large magnetic flux create induced currents on the surface of the CLL element 30. The induced currents produce a capacitance across the interdigitated finger 21, 22, and 23, within capacitive gaps 27 and 28. The capacitance obtained from the induced currents is sufficiently large to match both the inductance due to the current path formed by the interdigitated CLL element 30 and by the PEC ground plane 26, and the inductance of the electrically-small, rectangular semi-loop antenna 24.

The length, width, and height of the rectangular semi-loop antenna 24 play a role in tailoring the resistance and reactance of the matching/radiating element 30 to match it to, e.g., the 50-Ω coax-feedline 14, thus achieving an efficient, electrically-small antenna system 20. For example, the resonant coupling of the driven rectangular, semi-loop antenna 24 with the 2D interdigitated CLL element 30 enhances the resulting radiation resistance and reactance response of the antenna system 20. The length and height dimensions of the interdigitated CLL element 30 provide the major inductance of this 2D, magnetic-based EZ antenna system 20. The finger number, finger length, finger spacing and finger gap provide the major capacitance of this 2D, magnetic-based EZ antenna system 20.

The width of the rectangular, semi-loop antenna 24 contributes some to the inductance, but its overall effect to the tuning of the system is limited. The width of the rectangular, semi-loop antenna 24, however, impacts the conductor losses in the antenna system 20. Independent calculations of the CLL element 30 alone as a unit cell inclusion show that the CLL element 30 acts like a MNG medium, which agrees favorably with predictions. Thus, an MNG metamaterial is required to provide the necessary capacitance to achieve a resonant system and to enable the impedance matching of the inductive rectangular semi-loop antenna to the source.

2D Realization Based on Lumped Element Capacitors

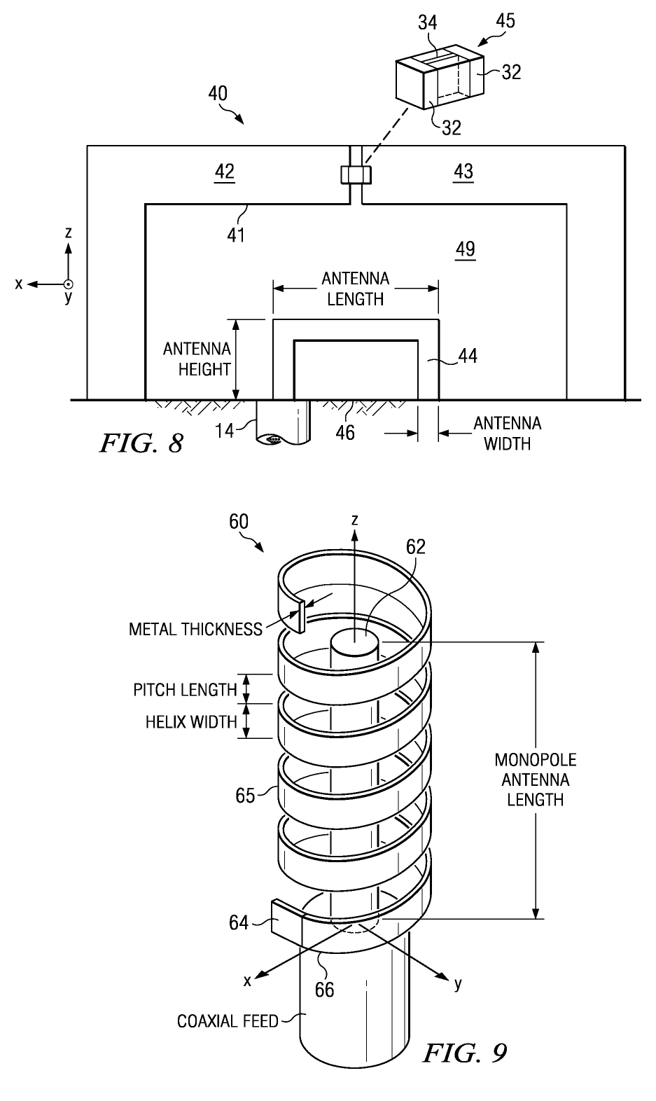

Alternatively, referring to FIG. 7 and FIG. 8, a 2D, planar, magnetic-based EZ antenna design 40 can be based, instead, on replacing the interdigitated capacitor 25 with a lumped element capacitor 45. As shown in FIG. 8, the lumped element capacitor 45 can includes a terminal electrodes 32 with a ceramic dielectric 34 therebetween. One advantage of using a lumped element capacitor 45 over the previous, interdigitated capacitor design is that the lumped element design further reduces conductor losses and, thus, increases the overall efficiency of the antenna system 40. Another advantage associated with using a lumped element capacitor 45 would be the ease with which one could tune the resonant frequency of the antenna system 40.

The alternative 2D, magnetic-based EZ antenna 40 includes a lumped element capacitor 45, such as a MuRata high-Q GJM lumped element capacitor. The total length, width, and thickness of this capacitor 45 are 1 mm, 0.5 mm, and 0.5 mm, respectively. The selected capacitor size code (EIA) is 0402. The design is readily adjusted to accommodate different capacitor dimensions.

The region 49 between the bottom matching/radiating element 41 and the finite PEC ground plane 46 captures the magnetic flux generated by the electrically-small, rectangular semi-loop antenna 44 that is driving it. The changes with time of this resonantly-large magnetic flux create induced currents on the two “arms” 42 and 43 of the matching/radiating element 50, which supplies the necessary current for the capacitor 45. The capacitance in the antenna system 40 is sufficiently large to match both the inductance due to the current path formed by the matching/radiating element 41 and the copper (PEC) ground plane 46 and due to the inductance of the electrically-small, rectangular semi-loop antenna 44.

The length, width, and height of the rectangular, semi-loop antenna 44 also play a role in the ability to tailor the resistance and reactance of the radiating element to the 50Ω coax-feedline 14, thus achieving an EESA system.

### Realizations of an Electric Antenna System

Electric-based EZ antenna systems are also disclosed. The first of these physical realizations of metamaterial-inspired EESAs was obtained by integrating an ENG medium with an electrically-small, electric monopole antenna over a finite PEC ground plane. The volumetric version uses a 3D cylindrical helix wire strip as a matching element that is excited by an electrically-small monopole antenna. The planar version is designed as an electrically-small printed monopole antenna radiating in the presence of a 2D meander-line. These electric-based EZ antennas are also naturally matched to a 50-Ω source and can be scaled linearly to a wide range of frequencies. The planar versions again offer an attractive alternative to well-known electric-based, electrically-small antenna designs due to their easy-to-build characteristic.

Three-Dimensional Realizations

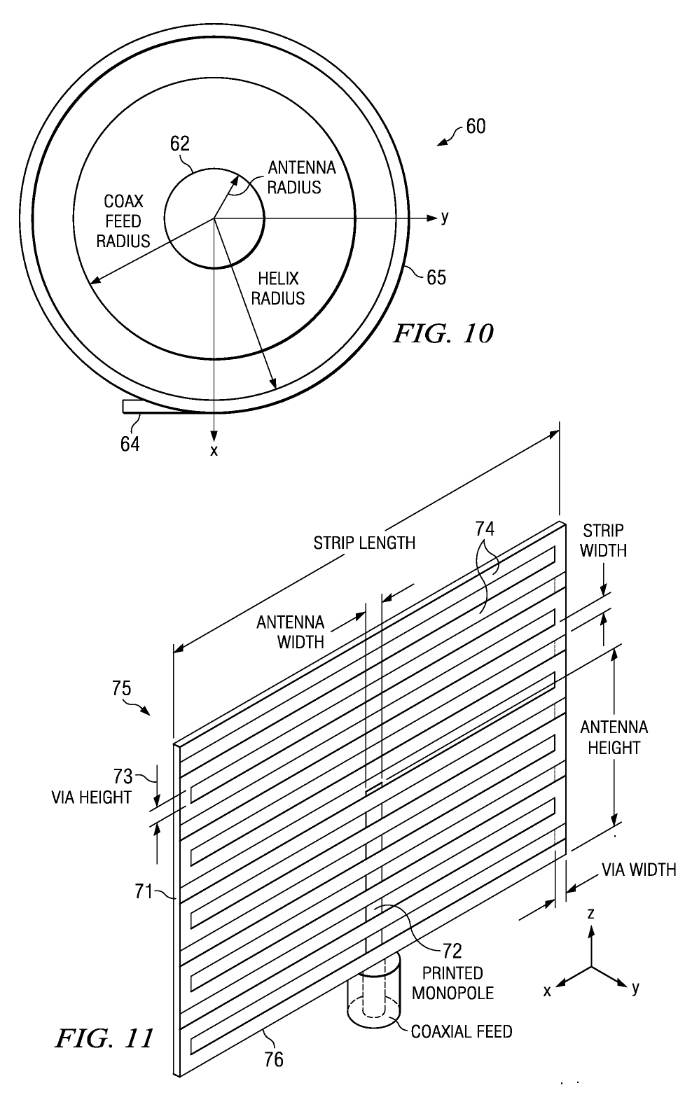

Referring to FIG. 9 and FIG. 10, a 3D, electric-based EZ antenna system 60 is shown. The antenna system 60 includes a 3D, cylindrical, helical, thin, copper metal strip 65 that is structured and arranged to capture the electric field radiated by an electric monopole antenna 62 in its near-field region. The electric-based EZ antenna system 60 is adapted to produce a relatively large induced current flow on the copper metal strip 65. The relatively large induced current flow on such an electrically-small, multi-turn, helical, copper metal strip 65 creates an inductance that can be used to form a natural RLC matching element. More particularly, the inductance produced by this antenna system 60 is sufficiently large to achieve a match to the large capacitance of the electrically-small monopole antenna 62.

The design specifications of the proposed 3D, electric-based EZ antenna system 60 are illustrated in FIG. 9. The 3D, cylindrical, helix, copper strip 65 is disposed in close proximity to the monopole antenna 62. A tiny copper block 64 is added to the beginning of the first turn of the helix strip 65 to ensure connectivity between the 3D, cylindrical, helical strip 65 and the finite PEC ground plane 66.

In operation, the electric field distribution from the monopole antenna 62 induces current along the surface of the helix strip 65, which generates a magnetic field and, hence, the desired inductance. By increasing the pitch length, the distance between adjacent turns in the 3D, helical structure 65 along its axis, the total inductance in the antenna system 60 can be reduced due to the lower copper strip density. The number of pitch turns in the electrically-small, 3D, helical strip 65 also can be adjusted to provide the necessary inductance to form the RLC matching element.

The length of the monopole antenna 62 determines the magnitude of the resonant coupling of the driving antenna to the 3D, helical strip 65. By reducing the monopole antenna 62 length, the resonant RLC behavior is reduced. As a result, the resonance effect diminishes for very short, electrically-small, monopole antennas 62. The length of the monopole antenna 62 also affects the ability to tailor the resistance of this radiator system 60 in order to match it to the 50-Ω source and, therefore, to achieve an electric-based, EESA system.

Increasing the width of the coils of the helical strip 65 and decreasing the pitch length produce a larger inductance to the resonant system 60. The monopole antenna radius 62 affects the reactance part of this electric-based antenna system 60. For example, a smaller antenna radius is necessary to produce a larger inductive value in order to maintain the resonance effect. Because they are both electrically thin, the monopole antenna radius and the copper metal thickness affect the conductor losses and, as a result, the overall efficiency of the 3D, electric-based EZ antenna system 60.

The multi-turn, helical strip 65 is disposed in close proximity to the monopole 62. Accordingly, the losses resulting from the changes in the current distributions due to the associated proximity effects can be as large as losses corresponding to the skin effect alone.

Two-Dimensional Realizations

The 3D, electric-based EZ antenna system 60 described above can be reduced to a 2D, planar design by integrating an electrically-small, printed, e.g., electrodeposited, monopole antenna 72 and a 2D, meander-line structure 75 on a laminate structure 71. As shown in FIG. 11, the electrically-small, printed monopole antenna 72 and the 2D, meander-line structure 75 are each disposed on opposite sides of a laminate structure 71. For example, the laminate 71 can be Rogers 5880 Duroid™, which has a 31 mils (0.787 mm) thick substrate and 0.5 oz. (17 μm) electrodeposited copper. The bottom of the 2D, meander-line 75 is connected directly to a finite PEC ground plane 76.

Independent calculations of the meander-line element 75 alone as a unit cell inclusion show that the element 75 acts like an ENG metamaterial medium, which is required to provide the necessary inductance to achieve a resonant system and to enable the impedance matching of the capacitive monopole antenna 72 to the source.

The extended, 2D, copper surface of the meander-line 75 serves as a current path for the induced current generated by the electric-field distribution of the electrically-small, printed, monopole antenna 72 fed through a finite PEC ground plane 76. The 2D, meander-line 75 is disposed in very close proximity to the monopole antenna 72, e.g., approximately λ₀/275. As a result, a large inductance is generated, which again allows the system 70 to form an RLC resonator.

Another valid explanation for the properties of the inductance can be made if one visualizes each electrically-small, copper strip 74 as a transmission line terminated in a short circuit. The complex impedance of such a transmission line is inductive. The entire meander-line 75 can then be thought of as a series of inductors that are driven by the electrically-small, printed, monopole antenna 72. Consequently, the meander-line 75 provides enough inductance to achieve the desired matching system.

Increasing the antenna height enhances the resonant coupling of the driving, printed monopole antenna 72 to the 2D, meander-line; and thus, it enhances the resulting resonant response of the antenna system. A thinner substrate thickness would also enhance the resonant coupling between the antenna 72 and the 2D, meander-line 75. The antenna width affects the reactance part of this antenna system 70. For example, a smaller printed monopole width requires a larger inductive value to maintain the resonance effect.

The mutual capacitance between adjacent copper strips 74 in the meander-line 75 depends in large part on the distance (or via height 73) that separates adjacent copper strips 74. Indeed, increasing the via height 73 between adjacent copper strips 74 in the meander-line 75 reduces the mutual coupling and, therefore, capacitance. Consequently, the resonance behavior shifts towards higher frequencies. When via height 73 is increased, the resonant effect, however, is reduced due to the lower copper strip density, i.e., the strip density determines the amount of current induced by the electric field distribution.

Increasing strip length and decreasing strip width both provide larger inductance to the resonant system, but with different magnitudes. This resonance phenomenon can be explained using transmission line theory. Indeed, the proposed antenna design is electrically-small and, thus, each strip length should be much smaller than λ₀/4. Consequently, the characteristic impedance of the given transmission line, which is to say, the inductive value of the proposed design, should increase as a tangent function when a longer strip length is used providing that the overall length still remains smaller than λ₀/4. Reducing the strip width, on the other hand, provides a logarithmic increase of the inductance dictated by the strip width and the substrate thickness ratio.

### Results of Computer Simulations

Various electrically-small, magnetic-based and electric-based antenna systems were simulated and their performance evaluated using the High Frequency Structure Simulator (HFSS) software developed by Ansoft, LLC, a subsidiary of ANSYS, Inc. of Canonsburg, Pa. For the purposes of this discussion IEEE standard definitions of terms for antennas, including ESA systems, are as follows:

Accepted power (AP) is the power delivered to the antenna terminals from the source. AP contains information about any mismatch between the source, the feedline, and the antenna. The AP by the antenna is given by the equation:

AP=(1−|Γ|²)Pᵢₙₚᵤₜ

in which Pᵢₙₚᵤₜ refers to the input power of the source and Γ refers to the reflection coefficient at the antenna. The reflection coefficient (Γ) is given by the equation:

Γ=(Zᵢₙₚᵤₜ−Z₀)/(Zᵢₙₚᵤₜ+Z₀)

in which Z₀ corresponds to the characteristic impedance of both the source and the feedline (which assumes that the feedline is matched to the source) and Zᵢₙₚᵤₜ corresponds to the input impedance of the antenna.

Mismatch or accepted power efficiency (AE) corresponds to the ratio of the AP to the input power Pᵢₙₚᵤₜ of the source and is given by the equation:

AE=AP/Pᵢₙₚᵤₜ=1−|Γ|².

Radiation efficiency (RE) describes the amount of power that propagates into the far field from the power delivered to the terminals of the antenna. More particularly, RE is equal to the power accepted by the antenna minus the power dissipated in the antenna and is given by the ratio of the total power radiated to the accepted power, which is to say:

RE=P_{rad}/AP

The overall efficiency (OE) of the antenna system takes into account all of the possible losses in a given antenna system and, more particularly, is the ratio of the total power radiated to the input power, which is to say:

OE=P_{rad}/Pᵢₙₚᵤₜ.

For a 1 Watt (W) source, OE describes what portion of that watt is radiated into the far field of the antenna system.

If the directivity of an antenna system is D, its realized gain is given by the equation:

G_{R}=OE×D.

“Electrically-small” herein connotes that the relationship between the radius (a) of the smallest sphere enclosing the entire antenna system and the wavelength (λ) of the source driving the antenna is less than or equal to unity (1), which is to say, that the radius (a) is contained within the Wheeler radiansphere, or:

ka=(2π/λ₀)a≦1.0,

in which k refers to the free space wave number and λ₀ refers to the free space wavelength for a source frequency, f₀, and is given by the equation:

λ₀=c/f₀

where c is the speed of light in free space.

If the antenna system is designed in the presence of an infinite perfect electric conductor (PEC) ground plane, only half of the Wheeler radiansphere is involved. Accordingly, the antenna system is generally said to be electrically small if ka≦0.5.

The default HFSS electrical properties were assigned for the copper, i.e., ∈=∈₀, μ=μ₀, and σ=5.8×10⁷ S/m. The radiation box for each design was created using a cube whose sides are at least λ₀/4 distance away from the radiating system and that has one face being assigned as the finite PEC ground plane. Initial meshing was applied to improve the convergence of each simulation.

We note that the presence of losses broadens the resonance and, hence, increases the bandwidth. The inclusion of the radiation efficiency factor, RE, in the calculation of the quality factor compensates for this broadening.

The copper metal used in Design 1 was assumed to have a 5.8×10¹⁷ Siemens/m conductivity, i.e., to model the copper essentially as a perfect electric conductor in order to explore the performance of the 3D magnetic-based EZ antenna under these ideal conditions. The conductivity of copper in all of other instances was always set equal to its well-known value: 5.8×10⁷ Siemens/m.

Three-Dimensional Magnetic Antenna System

The HFSS model of a 3D, magnetic-based EZ antenna system includes a semi-circular loop copper wire antenna that is connected to a finite PEC ground plane and fed by a 50-Ω coaxial-cable, an extruded CLL copper structure having two “J-sheets” that are connected to the finite PEC ground plane and having a specified vacuum gap that is uniformly held between the capacitor legs of the J-sheets, and a vacuum radiation box that surrounds the antenna system.

Table I and Table II (below) provide the variable specifications of four different EZ antenna designs at frequencies of 300 MHz, 1580 MHz, and 6000 MHz.

TABLE I
EZ Antenna Resonant Frequency Specifications, Wire Loop
Details, and Ground Plane Dimensions

| | Design | Loop Antenna | Metal Wire | Ground |
|---|---|---|---|---|
| | Frequency | Radius | Radius | Plane (x × y) |
| | (MHz) | (mm) | (mm) | (mm²) |
| Design 1 | 300 | 1.9 | 0.3 | 520 × 520 |
| Design 2 | 300 | 2.8 | 0.3 | 520 × 520 |
| Design 3 | 1580 | 3.1 | 0.3 | 135 × 135 |
| Design 4 | 6000 | 0.8 | 0.07 | 30.34 × 30.34 |

TABLE II
EZ Antenna Metamaterial Inspired Structure Dimensions

| | | | | | Stub | |
|---|---|---|---|---|---|---|
| | Height | Length | Depth | Spacing | Length | Copper |
| | along | along | along | along | along | Metal |
| | z-axis | y-axis | x-axis | y-axis | z-axis | Thickness |
| | (mm) | (mm) | (mm) | (mm) | (mm) | (mm) |
| Design 1 | 10 | 20 | 20 | 0.03 | 5.741 | 0.254 |
| Design 2 | 10 | 20 | 20 | 0.03 | 5.76 | 0.254 |
| Design 3 | 6.5 | 17.3 | 20 | 0.2 | 1.57 | 0.254 |
| Design 4 | 1.625 | 4.34 | 5 | 0.05 | 0.459 | 0.0762 |

Table III (below) summarizes the HFSS predicted radiation characteristics of these antenna systems.

TABLE III
Summary of the EZ Antenna Radiation Characteristics

| | Fᵣₑₛₒₙₐₙₜ | | FBW_{VSWR} | | AP | RE | OE | |
|---|---|---|---|---|---|---|---|---|
| | (MHz) | ka | (%) | Qᵣₐₜᵢₒ | (W) | (%) | (%) | D |
| Design 1 | 299.69 | 0.11 | 0.0123 | 20.5 | 1 | 100 | 100 | 2.68 |
| Design 2 | 299.97 | 0.11 | 0.0643 | 21.1 | 0.9969 | 18.73 | 18.67 | 2.68 |
| Design 3 | 1580 | 0.49 | 0.6834 | 28.3 | 0.9998 | 96.97 | 96.95 | 3.70 |
| Design 4 | 5997 | 0.46 | 0.6735 | 26.2 | 0.9939 | 92.67 | 92.10 | 3.16 |

A half-power matched VSWR fractional bandwidth was used to compute the Q value for each design at the resonance frequency f₀=ω₀/2π, which is to say,

Q_{VSWR}(ω₀)=2/FBW_{VSWR}(ω₀).

The ratio, Qᵣₐₜᵢₒ, of this Q_{VSWR} value and the Chu limit value, i.e.,

Q_{Chu}=1/ka+1/(ka)³,

where a is the radius of the minimum enclosing sphere and ka=ω₀a/c, was obtained using the equation:

Qᵣₐₜᵢₒ(ω₀)=2/(FBW_{VSWR}(ω₀)×Q_{Chu}(ω₀)×η),

where c is the speed of light in vacuum and η is the radiation efficiency.

To model a perfect electric conductor in order to explore the performance of the EZ antenna under ideal conditions, the simulated copper metal used in connection with Design 1 was assumed to have a conductivity of 5.8×10¹⁷ Siemens/m. As shown in Table III, the “loss-less” metal 300 MHz scenario (Design 1) produced a perfect radiation efficiency with ka=0.11, which confirms the physical realization of earlier theoretical predictions of a metamaterial-based, electrically small antenna. With realistic metal losses, the radiation efficiency of the antenna system decreases as the ka values decrease from the electrically-small antenna limit, ka=0.5, to zero.

A comparison of the Q values for each antenna design confirms that the amount of energy stored in the designed element, which provides the necessary capacitance, depends on the ka value of the system. Indeed, as the ka value approaches zero, the reactance of the loop antenna becomes less inductive and also approaches zero. This loop antenna behavior demonstrates that less stored energy is required to provide the requisite matching capacitance.

In contrast, as the ka value approaches the 0.5 limit, the reactance of the loop antenna becomes more inductive, requiring the antenna system to store more energy. A comparison of Design 3 and Design 4, corresponding to ka values of 0.49 and 0.46, respectively, shows that the design frequency and component dimension ratios are almost identical. Accordingly, the antenna system can be linearly scaled to any desired frequency.

The differences between Design 1 and Design 2 demonstrates that copper losses significantly impact the radiation efficiency of the resonant system. Indeed, the radiation efficiency and overall efficiency in Design 1, which had a copper conductivity value, were both 100 percent while the radiation efficiency and overall efficiency in Design 2 were over 81 percent less efficient, i.e., 18.73 percent and 18.67 percent, respectively.

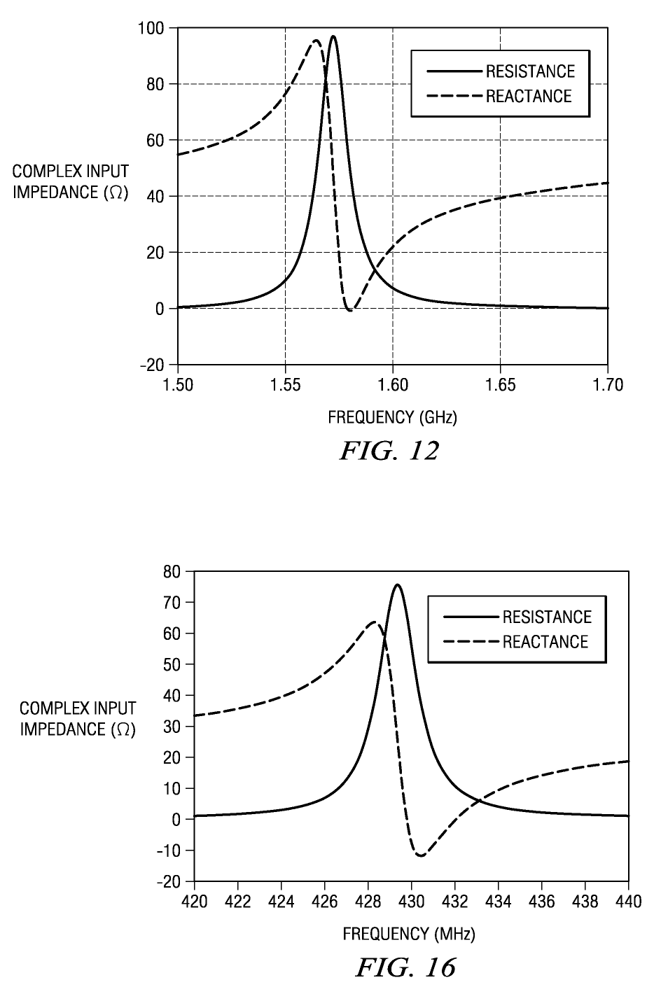

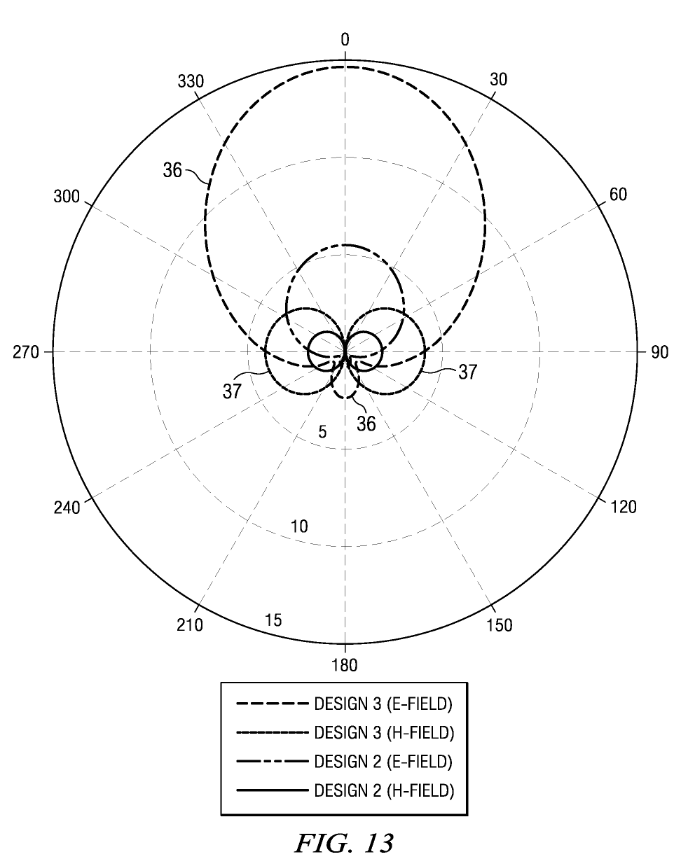

The performance of the scaled limit case at 300 MHz (Design 1) is essentially the same as the higher frequency versions (Design 3 and Design 4). The overall efficiencies of these electrically-small-limit systems are very high. The complex input impedance behavior and far-field radiation patterns for the Design 3, corresponding to the GPS-frequency, are shown in FIG. 12 and FIG. 13, respectively. The resistance and reactance curves in FIG. 12 exhibit characteristics analogous to the anti-resonant behavior of an electrically-small circular loop, i.e., a magnetic dipole antenna. In particular, it is clear from FIG. 12 that the antenna system is anti-resonant and, moreover, matched to the feedline at the source frequency.

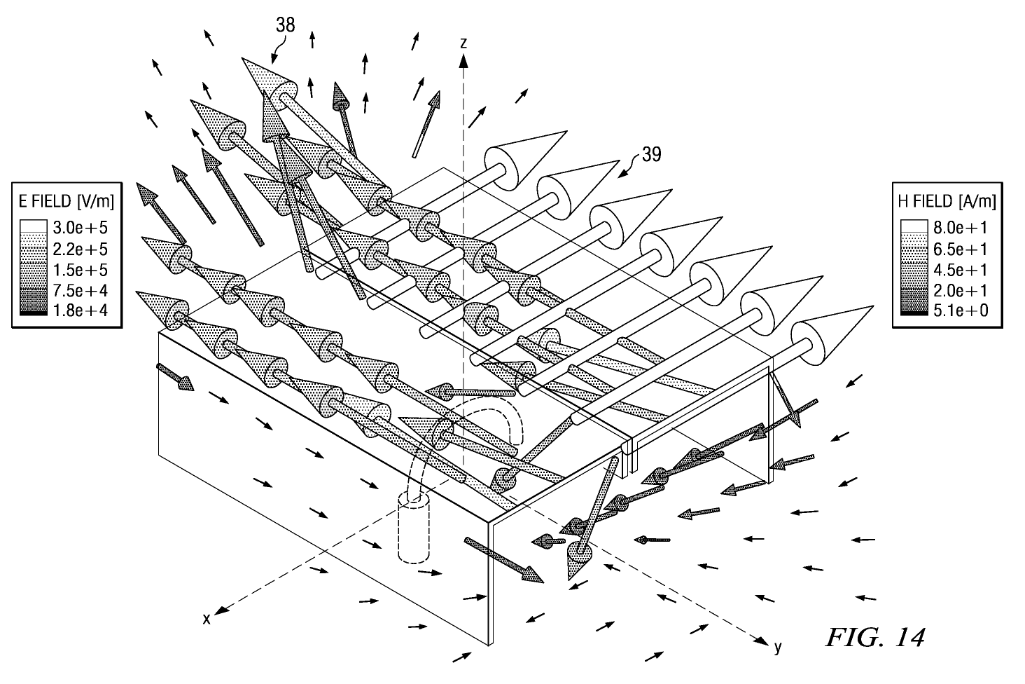

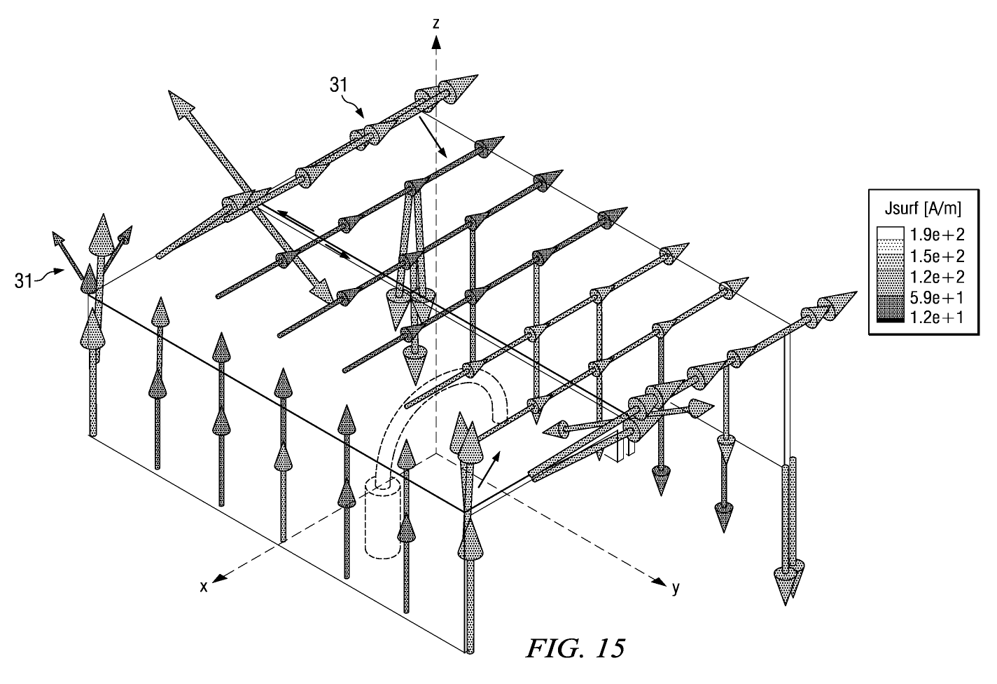

FIG. 13 illustrates that the antenna system acts like a magnetic dipole antenna over a PEC ground plane. FIG. 14 and FIG. 15 show E-field 36 and H-field 37 vector plots using xy-plane cuts in the stub and slightly above the semi-circular loop antenna, respectively, as well as current vector plots 31 on the metamaterial-inspired structure. From FIG. 14 and FIG. 15, one clearly sees that the metamaterial-inspired radiating structure acts like a uniformly extruded CLL element.

Two-Dimensional, Interdigitated Capacitor Magnetic Antenna System

The HFSS model of a 2D, magnetic-based EZ antenna system includes a rectangular, semi-loop copper antenna that is connected to a finite PEC ground plane and fed by a 50-Ω coaxial-cable, a pre-determined number of interdigitated capacitor fingers that are uniformly positioned to have the same gap and spacing across each element and, further, having the two main “arms” connected to the finite PEC ground plane, and a vacuum radiation box that surrounds the antenna system.

The distance between the two main “arms” was determined by the physical length of the capacitor. The terminal electrodes and ceramic material parameters were assigned as those of tin and ceramic, respectively, to obtain an accurate numerical model of the physical structure.

Tables IV and V (below) give the variable specifications of four different 2D, magnetic-based EZ antennae (Design 5-Design 8) that are achieved with interdigitated capacitor designs at three different frequencies: 300 MHz, 430 MHz, and 1580 MHz. The copper conductivity value for Design 5 was assumed to be 5.8×10¹⁷ Siemens/m. to model an ideal loss-less structure. For Designs 6-8 the copper conductivity value was 5.8×10⁷ Siemens/m.

TABLE IV
2D Magnetic-based EZ Antenna Resonant Frequency Specifications

| | | Antenna | Antenna | | | |
|---|---|---|---|---|---|---|
| | | Length | Height | | Number of | |
| | Design | along x- | along z- | Antenna | Interdigitated | Ground |
| | Frequency | axis | axis | Width | Capacitor | Plane (x × y) |
| | (MHz) | (mm) | (mm) | (mm) | Fingers | (mm²) |
| Design 5 | 300 | 2 | 1.4 | 0.6 | 10 | 536 × 536 |
| Design 6 | 430 | 18 | 5.2 | 2.4 | 10 | 521 × 521 |
| Design 7 | 430 | 25 | 12 | 4 | 3 | 510 × 510 |
| Design 8 | 1580 | 5 | 3 | 1 | 3 | 137 × 137 |

TABLE V
Dimensions of the 2D Magnetic-based EZ Antenna
Integrated with an Interdigitated Capacitor

| | | | Finger | | | |
|---|---|---|---|---|---|---|
| | Height | Length | Length | Finger | Finger | Finger |
| | along | along | along | Width along | Gap along | Spacing along |
| | z-axis | y-axis | x-axis | z-axis | z-axis | z-axis |
| | (mm) | (mm) | (mm) | (mm) | (mm) | (mm) |
| Design 5 | 9.6 | 18 | 10.1 | 0.254 | 0.02 | 0.02 |
| Design 6 | 38 | 73 | 29.8 | 2.032 | 1.2192 | 1.2192 |
| Design 7 | 38 | 80 | 59.7 | 1.9 | 2.7 | 2.7 |
| Design 8 | 10 | 22 | 10.5 | 0.7 | 0.15 | 0.15 |

Table VI (below) summarizes the HFSS predicted radiation characteristics of these 2D antenna systems.

TABLE VI
Summary of the 2D Magnetic-based EZ Antenna Integrated with an
Interdigitated Capacitor Radiation Characteristics

| | Fᵣₑₛₒₙₐₙₜ | | FBW_{VSWR} | | AP | RE | OE | |
|---|---|---|---|---|---|---|---|---|
| | (MHz) | ka | (%) | Q/Q_{Chu} | (W) | (%) | (%) | D |
| Design 5 | 309.557 | 0.085 | 0.007 | 17.21 | 0.997 | 100 | 99.70 | 2.91 |
| Design 6 | 430.02 | 0.475 | 1.083 | 20.08 | 0.992 | 80.14 | 79.50 | 3.78 |
| Design 7 | 430.42 | 0.497 | 1.300 | 17.26 | 0.995 | 87.83 | 87.40 | 3.64 |
| Design 8 | 1577.8 | 0.492 | 1.267 | 19.99 | 0.997 | 76.93 | 76.76 | 3.66 |

Referring to Table VI, at a design frequency of 300 MHz (Design 5) an overall efficiency of 99.7% was produced, which agrees with theoretical predictions for the 3D magnetic-based EZ antenna. As the electrical size of the antenna system decreases, overall radiation efficiencies decrease from about 90% at the electrically-small, antenna limit (ka=0.5) (Design 7) to zero.

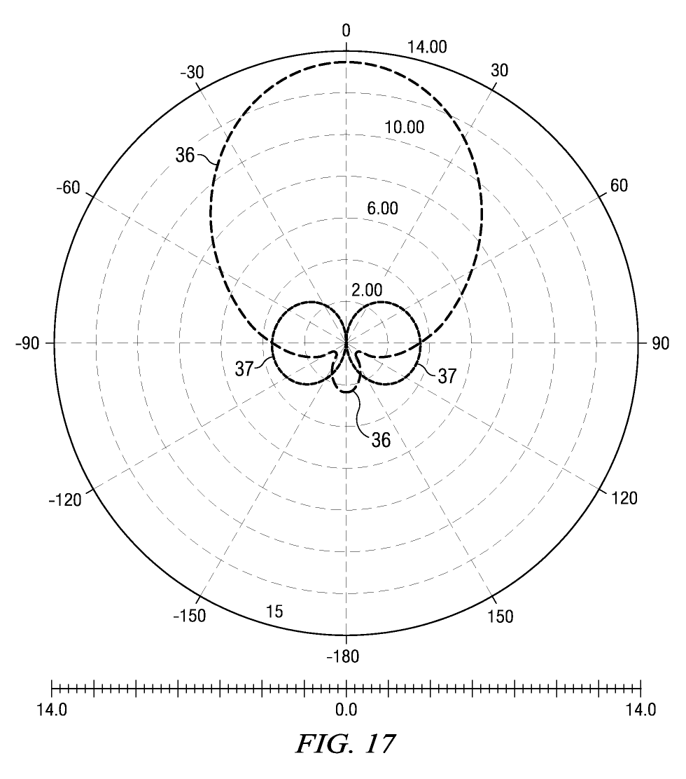

The predicted complex impedance values and the far-field E-field 36 and H-field 37 patterns for Design 6 are shown, respectively, in FIG. 16 and FIG. 17. The anti-resonant nature of the input impedance is apparent in FIG. 16. Furthermore, the E-field pattern 36 in FIG. 17 is clearly a maximum along the normal to the ground plane. It is also worth noting that, because they are electrically-small, the far-field patterns 36 and 37 in FIG. 17 corresponding to the 2D, magnetic-based EZ antenna are nearly identical to the far-field patterns 36 and 37 shown in FIG. 15 for a corresponding 3D, EZ antenna system. Comparison of reflection coefficients obtained from the numerical and experimental results demonstrates very good agreement.

The dimensions of the 2D, magnetic-based EZ antenna achieved with an interdigitated capacitive element are linearly scalable to any desired frequency. Scalability can also be seen from the frequency and component dimension ratios for Design 7 and Design 8. The radiation efficiency comparisons of Design 6 and Design 7 also show that the copper losses significantly impact the overall efficiency of the 2D, magnetic-based EZ antenna achieved with an interdigitated capacitor. This occurs because the antenna system is highly resonant. Consequently, an important practical criterion is to design a 2D antenna system using a minimum number of interdigitated capacitor fingers, to reduce copper losses and, thereby, to enhance the overall efficiency.

The overall efficiencies of these electrically-small-limit antenna systems are relatively high but slightly less than the 3D, magnetic-based EZ antenna predictions. Comparisons of the 2D and 3D, magnetic-based EZ antenna systems reveal that for the same design frequency, a 3D, magnetic-based EZ antenna design is more efficient. The reduction of the extruded CLL element in the 3D, magnetic-based EZ antenna design to the planar interdigitated CLL element in the 2D, magnetic-based EZ antenna design reduces the amount and magnitude of the current flow on the CLL element. Consequently, the reduced current flow reduces the conduction losses.

The far-field E-field 36 and H-field 37 patterns and surface current on the matching/radiating element demonstrates behavior similar to the 3D version. Indeed, the 2D, magnetic-based EZ antennas also act as horizontal magnetic dipoles over a PEC ground plane. The dielectric loss of the 2D, magnetic-based EZ antenna achieved with an interdigitated capacitor contributes an increase of about 2 percent over the total loss associated with the all-metal 3D version. The overall efficiency depends on the frequency of operation.

Two-Dimensional, Lumped Element Capacitor Magnetic EZ Antenna System

The HFSS model of a lumped element capacitor, magnetic-based, 2D, EZ antenna system includes a rectangular, semi-loop, copper antenna that is connected to a finite PEC ground plane and fed by a 50-Ω coaxial-cable, a lumped element capacitor that is connected between two main “arms”, which are connected to a finite PEC ground plane, and a vacuum radiation box that surrounds the antenna system. The distance between the two main “arms” was determined by the physical length of the capacitor. The terminal electrodes and ceramic material parameters of the lumped element capacitor were assigned as those of tin and ceramic, respectively, to obtain an accurate numerical model of the physical structure of the capacitor.

A lumped-RLC boundary condition was applied to a 2D rectangle that stretches between the two terminal electrodes and supplies the lumped element capacitance of the antenna system model. Another numerical model for the 2D, magnetic-based antenna system integrated with a lumped element capacitor was also used to validate the accuracy of the imposed lumped-RLC boundary condition by using capacitor data library provided by Panasonic on the Web site http//industrial.panasonic.com.

In order to use the Panasonic lumped capacitor library, the lumped-RLC boundary condition was replaced with a lumped port in the HFSS design and all the other design variables were kept the same. Next, the HFSS model was inserted into the ANSOFT Designer as a sub-circuit and simulated with the measured Panasonic capacitor values. Only the HFSS numerical model was used because it provided more information about antenna system radiation characteristics.

Tables VII and VIII (below) provide the variable specifications of three different 2D, magnetic-based EZ antennas (Designs 9-11) achieved with a lumped element capacitor design at three different frequencies: 100 MHz, 450 MHz, and 1575 MHz.

TABLE VII
Lumped Capacitor-based 2D Magnetic-based EZ
Antenna Resonant Frequency Specifications

| | | | Antenna | | |
|---|---|---|---|---|---|
| | | Antenna | Height | | |
| | Design | Length | along | Antenna | Ground |
| | Frequency | along x-axis | z-axis | Width | Plane (x × y) |
| | (MHz) | (mm) | (mm) | (mm) | (mm²) |
| Design 9 | 100 | 50 | 15 | 6 | 1640 × 1640 |
| Design 10 | 450 | 32 | 10.4 | 6 | 519 × 519 |
| Design 11 | 1575 | 8 | 2 | 1.5 | 132 × 132 |

TABLE VIII
Lumped Capacitor-based 2D Magnetic-based EZ Antenna
Dimensions and Lumped Element Capacitance Values

| | Height | Length | Width | Lumped Element |
|---|---|---|---|---|
| | along z-axis | along y-axis | along y-axis | Capacitance |
| | (mm) | (mm) | (mm) | (pF) |
| Design 9 | 70 | 70 | 10 | 15 |
| Design 10 | 36.8 | 35.75 | 10.75 | 1.5 |
| Design 11 | 8.3 | 9.25 | 3 | 0.6 |

The HFSS predicted radiation characteristics of these 2D antenna systems are given in Table IX.

TABLE IX
Summary of the Lumped Capacitor-based 2D
Magnetic-based EZ Radiation Characteristics

| | Fᵣₑₛₒₙₐₙₜ | Q/ | FBW_{VSWR} | | AP | RE | OE | |
|---|---|---|---|---|---|---|---|---|
| | (MHz) | ka | (%) | Q_{Chu} | (W) | (%) | (%) | D |
| Design | 98.70 | 0.202 | 0.285 | 14.48 | 0.996 | 40.06 | 39.9 | 2.79 |
| 9 | | | | | | | | |
| Design | 452.52 | 0.488 | 1.414 | 14.28 | 0.967 | 92.87 | 89.8 | 3.83 |
| 10 | | | | | | | | |
| Design | 1576.3 | 0.417 | 0.895 | 17.75 | 0.999 | 78.28 | 78.2 | 3.58 |
| 11 | | | | | | | | |

Referring to Table IX, the reflection coefficients obtained from the numerical and experimental results demonstrate very good agreement. Furthermore, comparisons of Design 7 and Design 10, both of which are close to ka˜0.5, show that the 2D, magnetic-based EZ antenna achieved with a lumped element capacitor design can further improve the overall efficiency of the antenna system, i.e., the efficiency of Design 10 for a lumped element capacitor is approximately 4% larger than Design 7 for an interdigitated finger element.

Three-Dimensional, Electric-Based Antenna System

Tables X and XI (below) provide the variable specifications of three different 3D, electric-based EZ antenna designs at three different frequencies: 300 MHz, 1000 MHz, and 1300 MHz (Designs 12-14).

TABLE X
3D Electric-based EZ Antenna Resonant Frequency Specifications

| | | | Monopole | |
|---|---|---|---|---|
| | Design | Monopole Antenna | Antenna | Ground |
| | Frequency | Length along | Radius | Plane (x × y) |
| | (MHz) | z-axis (mm) | (mm) | (mm²) |
| Design 12 | 300 | 11.0 | 0.5 | 540 × 540 |
| Design 13 | 1000 | 7.4 | 0.5 | 182 × 182 |
| Design 14 | 1300 | 6.0 | 0.5 | 182 × 182 |

TABLE XI
3D Electric-based EZ Antenna Metamaterial-inspired
Structure Dimensions

| | | | | Copper | |
|---|---|---|---|---|---|
| | Pitch Length | Helix Width | Number of | Helix | Metal |
| | along z-axis | along x-axis | Helix | radius | Thickness |
| | (mm) | (mm) | Turns | (mm) | (mm) |
| Design 12 | 1.5 | 0.8 | 10 | 5 | 0.8 |
| Design 13 | 1.5 | 0.8 | 10 | 1.7 | 0.8 |
| Design 14 | 1.6 | 0.8 | 10 | 1.5 | 0.1 |

The HFSS predicted radiation characteristics of these 3D electric-based antenna systems are given in Table XII.

TABLE XII
Summary of the 3D Electric-based EZ Antenna Radiation
Characteristics

| | Fᵣₑₛₒₙₐₙₜ | Q/ | FBW_{VSWR} | | AP | RE | OE | |
|---|---|---|---|---|---|---|---|---|
| | (MHz) | ka | (%) | Q_{Chu} | (W) | (%) | (%) | D |
| Design | 306.9 | 0.1 | 0.437 | 4.30 | 0.968 | 13.74 | 13.3 | 0.95 |
| 12 | | | | | | | | |
| Design | 1035.8 | 0.347 | 1.575 | 6.08 | 0.995 | 77.48 | 77.1 | 1.14 |
| 13 | | | | | | | | |
| Design | 1308 | 0.462 | 2.379 | 8.01 | 0.994 | 84.95 | 84.52 | 1.35 |
| 14 | | | | | | | | |

The overall radiation efficiencies of the 3D, electric-based antenna systems depend on their electrical sizes. This behavior agrees with what was determined for the corresponding magnetic-based cases. Overall efficiency decreases from nearly 85% at the electrically-small antenna limit ka=0.5 (Design 14) to zero as the electrical size of the antenna system decreases.

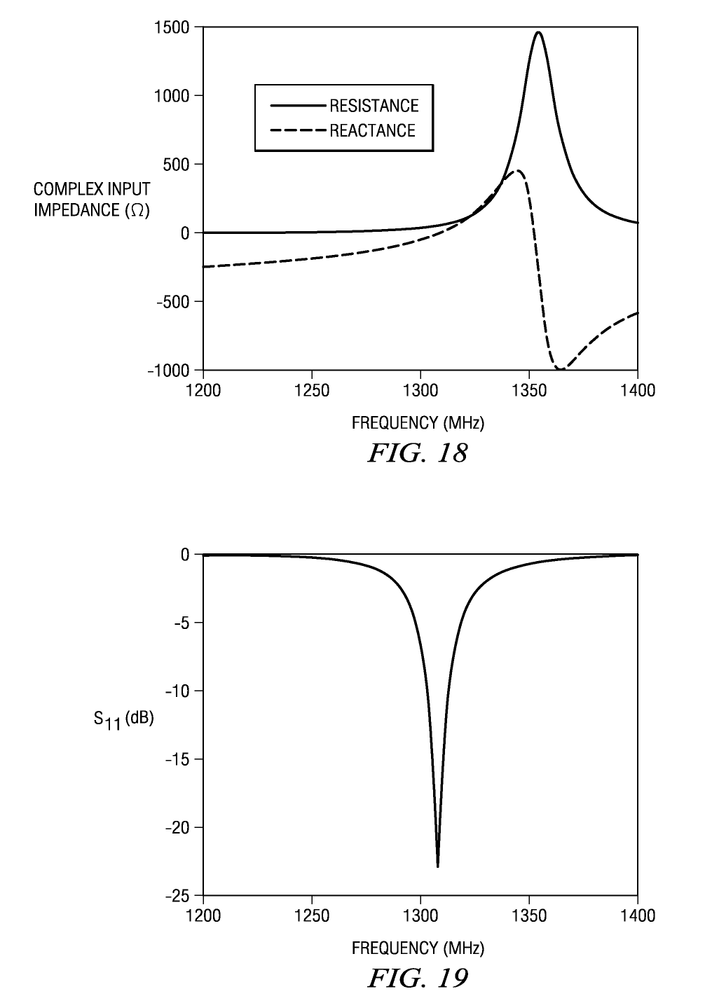

The predicted complex input impedance and corresponding S₁₁ values for a 50-Ω source obtained for Design 12 are provided in FIG. 18 and FIG. 19, respectively. From variable data in Tables X and XI (above) and the predictions in Table XII (above), the antenna systems can be designed at any desired frequency primarily by tuning the helix radius and the monopole antenna length. Comparisons of the FBW_{VSWR} for the 3D, electric-based antenna system (Table XII) and for the magnetic-based antenna system (Table III) demonstrate that the electric-based designs provide larger FBW_{VSWR} bandwidths, which is to say that, for a given electrical length, magnetic-based antenna systems have about 50% less FBW_{VSWR} than electric-based antenna systems due to the anti-resonant behavior of the former.

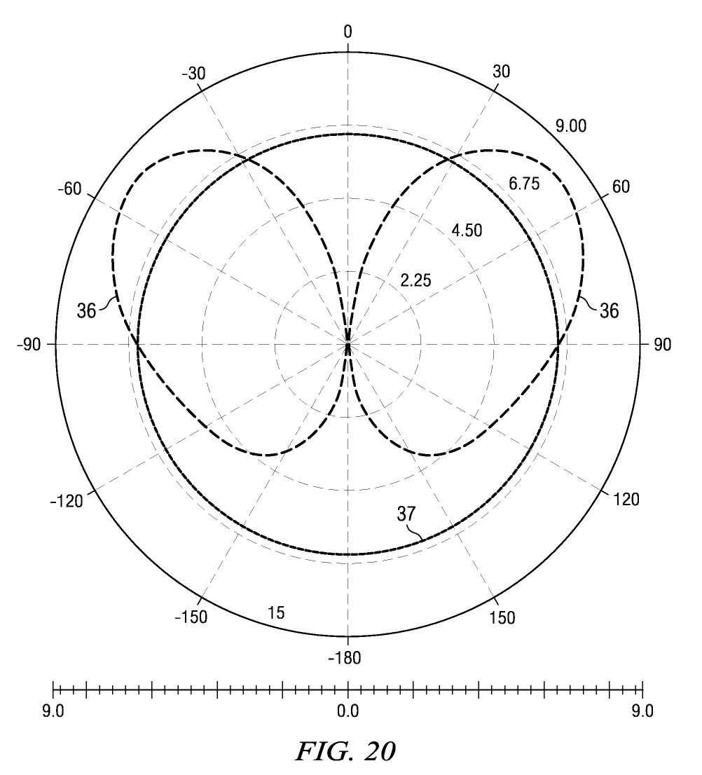

Far-field radiation patterns 36 and 37 obtained for Design 14 are shown in FIG. 20. Because the ground plane is finite rather than the assumed infinite, the E-field pattern 36 does not provide an exact match to the well-known monopole antenna radiation pattern.

Two-Dimensional, Electric-Based Antenna System

Tables XIII and XIV (below) provide variable specifications of three different 2D, electric-based EZ antenna designs (Designs 15-17) at two different frequencies: at 430 MHz and 1373 MHz.

TABLE XIII
2D Electric-based EZ Antenna Resonant Frequency Specifications

| | | | Monopole | |
|---|---|---|---|---|
| | Design | Monopole Antenna | Antenna | Ground |
| | Frequency | Height along | Width along | Plane (x × y) |
| | (MHz) | z-axis (mm) | x-axis (mm) | (mm²) |
| Design 15 | 430 | 17.0 | 1.5 | 442 × 442 |
| Design 16 | 430 | 28.0 | 1.5 | 500 × 500 |
| Design 17 | 1373 | 8.3 | 1.5 | 156 × 156 |

TABLE XIV
2D Matching Meander-line Element Dimensions

| | | Copper | Copper | | | |
|---|---|---|---|---|---|---|
| | Total | Strip | Strip | Number of | Via | Via |
| | Height | Length | Width | Copper | Height | Width |
| | (mm) | (mm) | (mm) | Strips | (mm) | (mm) |
| Design 15 | 33.274 | 41 | 1.524 | 11 | 1.651 | 1.016 |
| Design 16 | 46.15 | 49.5 | 4.75 | 5 | 5.6 | 3.1 |
| Design 17 | 14.732 | 18 | 1.524 | 5 | 1.778 | 1.016 |

The HFSS predicted radiation characteristics of these 2D, electric-based antenna systems are given in Table XV (below).

TABLE XV
Summary of the 2D Electric-based EZ Antenna Radiation
Characteristics

| | Fᵣₑₛₒₙₐₙₜ | Q/ | FBW_{VSWR} | | AP | RE | OE | |
|---|---|---|---|---|---|---|---|---|
| | (MHz) | ka | (%) | Q_{Chu} | (W) | (%) | (%) | D |
| Design | 429.9 | 0.352 | 2.32 | 5.77 | 0.999 | 57.86 | 57.80 | 1.18 |
| 15 | | | | | | | | |
| Design | 430.4 | 0.494 | 3.60 | 5.9 | 0.996 | 93.10 | 92.75 | 1.46 |
| 16 | | | | | | | | |
| Design | 1373 | 0.497 | 4.079 | 5.35 | 0.985 | 89.34 | 88.00 | 1.44 |
| 17 | | | | | | | | |

The overall radiation efficiencies of the 2D, electric-based antenna systems depend on the electrical size of the antenna system. In contrast to Design 16, Design 15 demonstrates a well-balanced, smaller, yet reasonably efficient design.

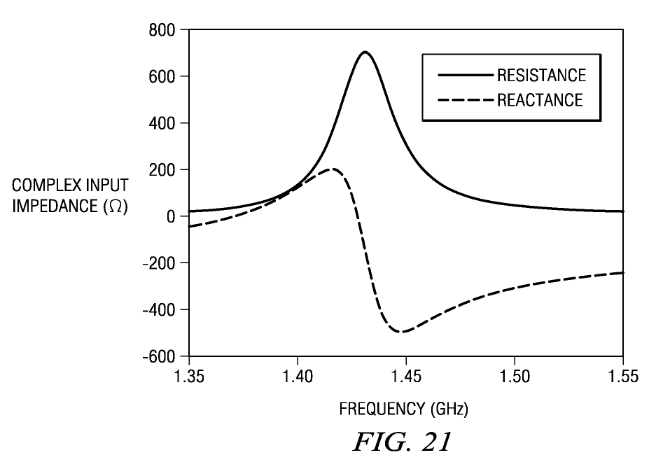

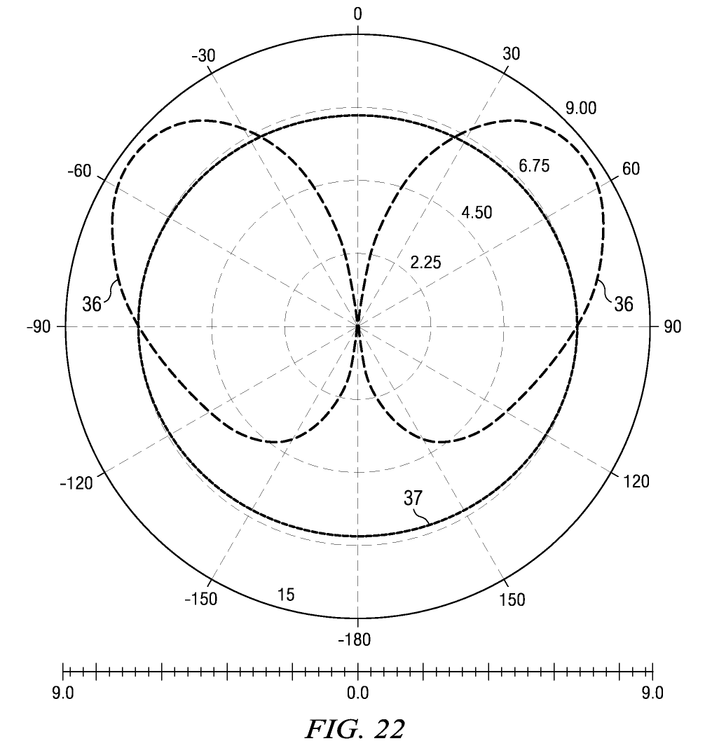

The predicted complex impedance values and the far-field patterns for Design 17 are shown, respectively, in FIG. 21 and FIG. 22. The expected resonant nature of the input impedance is apparent in FIG. 21. The E-field pattern 36 in FIG. 22 is clearly a maximum along the ground plane as would be expected for a monopole configuration.

It is worth noting that because they are electrically-small, the patterns in FIG. 22 for the 2D, electric-based EZ antenna are nearly identical to the patterns shown in FIG. 20 for the corresponding 3D electric-based EZ antenna.

### Validation Testing of 2D and 3D EZ Antennas

### EXAMPLE 1

The design and performance characteristics of both 2D and 3D, electrical-based and magnetic-based EZ antennas have been shown through computer simulation to be naturally matched to a 50-Ω source and, moreover, to have high overall efficiencies. The 2D and 3D, EZ antenna systems are linearly scalable to a wide range of frequencies without any significant fabrication limitations. To validate the numerical predictions, several of the 2D, magnetic- and electric-based EZ antennas were fabricated and tested. Due to a limitation in available measurement tools and expertise, only S-parameters were measurable locally. To obtain at least one set of efficiency measurements, samples of one design were sent to the National Institute of Standards and Technology (NIST) in Boulder, Colo. for testing.

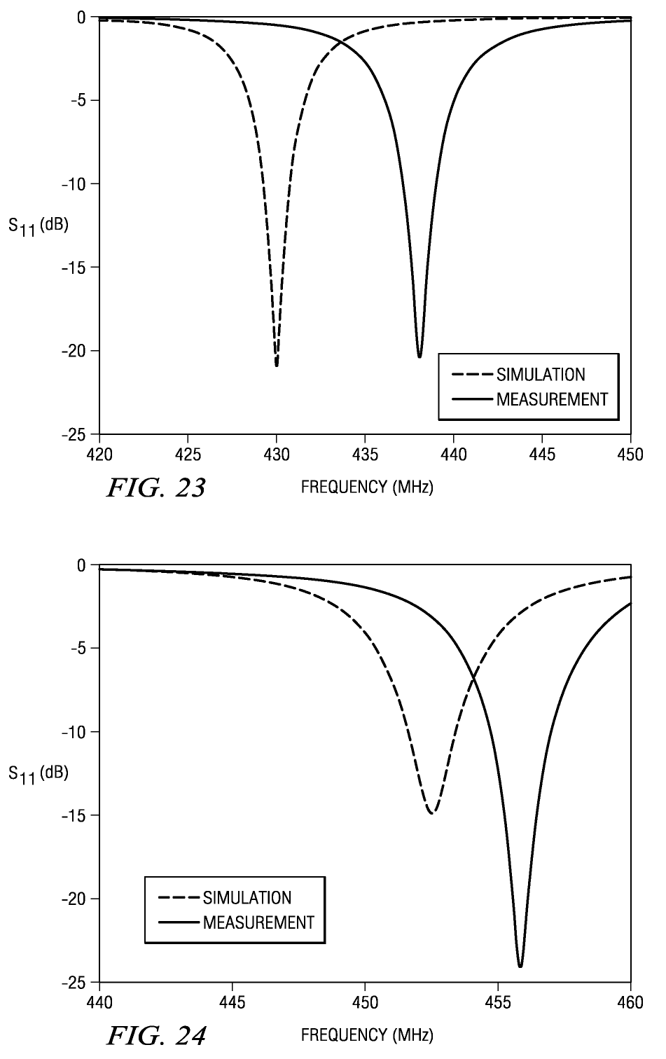

For example, Design 6 was fabricated using a photolithography technique and was mounted on a 0.8 mm thick copper ground plane. The S-parameters were measured using a Hewlett-Packard (HP) 8720C network analyzer calibrated with a standard SOLT method. The simulated and measured S₁₁ values for the fabricated Design 6 antenna system are compared in FIG. 23.

The measured S₁₁ values show very good agreement with the simulated data. Indeed, the predicted resonant frequency is only 1.88% different from the measured value of 438.1 MHz. The measured FBW_{VSWR} was 1.3%, which is also in very good agreement with the predicted value.

### EXAMPLE 2

Design 10 was fabricated using a photolithography technique and was mounted on a 0.8 mm thick copper 15 mm×15 mm ground plane. The relatively small copper ground plate was then taped to a larger (521 mm×521 mm) copper ground plane.

The predicted and measured S₁₁ values are shown in FIG. 24. These data demonstrate a very good agreement with the HFSS predictions. Indeed, the predicted resonant frequency is only 0.7% below the measured value of 455.8 MHz. The measured FBW_{VSWR} was 1.5%, which also is in very good agreement with the predicted value.

### EXAMPLE 3

Two Design 17 electric-based EZ antenna were fabricated using a photolithography technique. Each was mounted on a 0.8 mm thick, 156 mm×156 mm large copper ground plane.

Although the total power radiated by an ESA has been measured in a variety of ways, each measurement technique has it shortcomings. However, for comparison purposes, a reverberation chamber at NIST-Boulder was used for the power efficiency measurements.

A reverberation chamber is basically a shielded room, i.e., a room having grounded high conducting metallic walls, having an arbitrarily shaped metallic paddle, i.e., a stirrer or a tuner, that rotates. The rotating paddle creates a statistically uniform environment throughout the working volume of the chamber. Historically, reverberation chambers were used as high-field-amplitude test facilities for electromagnetic interference (EMI) and compatibility (EMC) effects. Presently, reverberation chambers are being used for a wide range of other measurement applications, which include, but are not limited to, determining: (1) radiated immunity of components and large systems; (2) radiated emissions; (3) shielding characterizations of cables, connectors, and materials; (4) antenna efficiency; (5) probe calibration; (6) characterization of material properties; (7) absorption and heating properties of materials; and (8) biological and biomedical effects. Although much of the research and applications of reverberation chambers to date have concerned EMC/EMI measurements, reverberation chamber applications to antennas and wireless devices began to emerge over the past few years.

When a source, i.e., an antenna under test (AUT), is placed in a reverberation chamber, energy radiates from the antenna and interacts with, i.e., reflects off, the chamber walls and the paddle. This energy is monitored at a receiving antenna that is disposed in the chamber. Accordingly, the total power received at the receiving antenna corresponds to the energy difference of the energy radiated by the source minus the energy lost into the chamber walls, including energy lost into any cables and/or other objects disposed inside the chamber.

Reverberation chambers are an ideal environment for measurements of the total radiated power and overall efficiency of antennas. However, in these types of measurements the losses in the chamber wall must be calibrated out. This is accomplished by using a known, i.e., a well characterized, antenna as a reference source. In this approach, measurements at the receive antenna are first obtained with the AUT. Next, measurements at the receive antenna are taken with the reference source, i.e., the AUT is replaced with the reference antenna.

In the NIST reverberation chamber, a dual-ridged horn antenna was used for the reference antenna for all of the measurement results discussed below. The overall efficiency of the horn antenna was determined previously to be 94%. The ratio of the total power received from the AUT to that from the reference antenna gives a measure of the relative total radiated power and, hence, the relative overall efficiency, which is to say, a measure of the overall efficiency of the AUT relative to that of the reference antenna. Those of ordinary skill in the art can appreciate that radiated field patterns of the AUT cannot be obtained from reverberation chamber measurements.

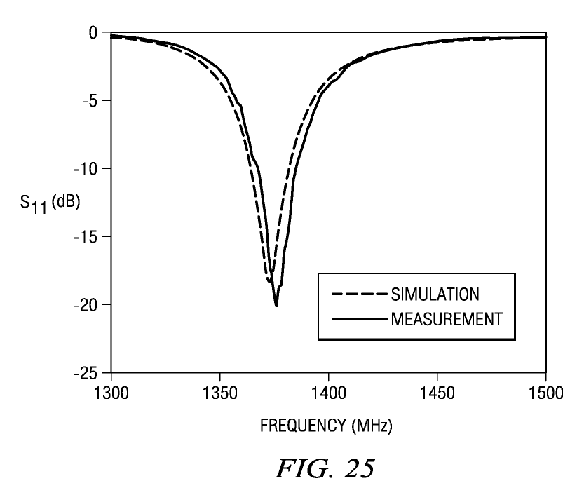

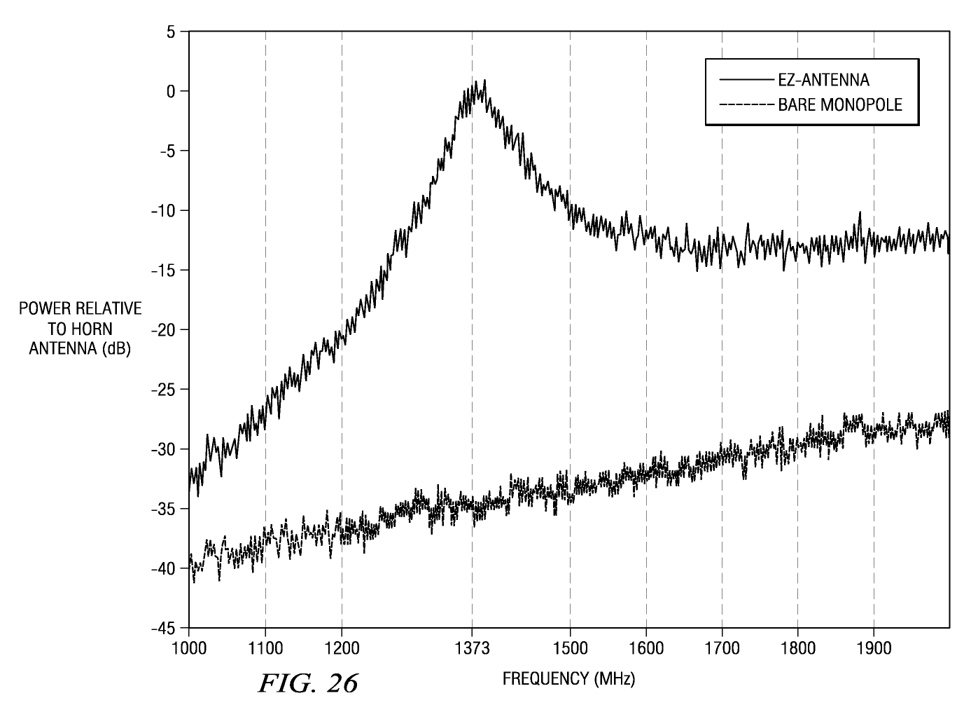

The predicted and measured S₁₁ values and the measured total radiated power relative to the reference horn antenna for the Design 17 fabricated 2D electric-based EZ antenna are given in FIG. 25 and FIG. 26, respectively. The measured relative overall efficiency, i.e., the overall efficiency of the Design 17 EZ antenna relative to that of the horn antenna, is approximately equal to or slightly greater than that of the reference horn antenna itself at the design frequency of 1373 MHz. Because the efficiency of the reference horn antenna is 94%, the measured overall efficiency of the Design 17 metamaterial-inspired, 2D, electric-based EZ antenna system was determined to exceed 94%.

The total radiated power response of the bare monopole antenna relative to the reference horn is shown in FIG. 26. The bare monopole antenna without the metamaterial-inspired, near-field parasitic element was obtained by removing the substrate and the associated 2D meander-line. It should be noted that the bare monopole antenna is electrically-small and is not resonant at the design frequency.

Numerically, it was predicted at 1373 MHz that the antenna's input impedance would be Z_{bare}=0.561−j535.9Ω giving a reflection coefficient magnitude equal to 0.9998 and that its total radiated power would be P_{rad,bare}=3.796×10⁻⁴ W. In short, the ratio of the total power radiated by the bare monopole antenna to the reference horn was predicted to be −33.94 dB.

The measured reflection coefficient was S₁₁=0.999 at 1373 MHz and the measured power ratio was −34.08 dB, which are both in very good agreement with their predicted values. Consequently, FIG. 26 demonstrates, as is well known, that an electrically-small monopole by itself and with no matching circuit of any kind is a poor radiator. In contrast, FIG. 26 also demonstrates how the presence of a specifically designed metamaterial-inspired near-field parasitic element can dramatically improve the total power radiated by the bare copper monopole antenna. More particularly, FIG. 26 shows that the measured total radiated power of the 2D electric-based EZ antenna at 1373 MHz was approximately 35 dB larger than the measured total radiated power of the bare copper monopole antenna, where both individual total radiated power values were obtained relative to the reference horn.

These measured results confirm that the design methodologies are valid and, moreover, that the theoretical metamaterial-based and physical metamaterial-inspired antenna systems provide an attractive alternative to existing electrically-small antenna designs. The measured FBW_{VSWR} was 4.1%; and, because the radiation efficiency can be obtained from the S₁₁ and overall efficiency values at 1376.16 MHz, the corresponding Q and Q/Q_{Chu} values at the resonance frequency were 49.15 and 4.91, respectively, which are in very good agreement with the predicted value.

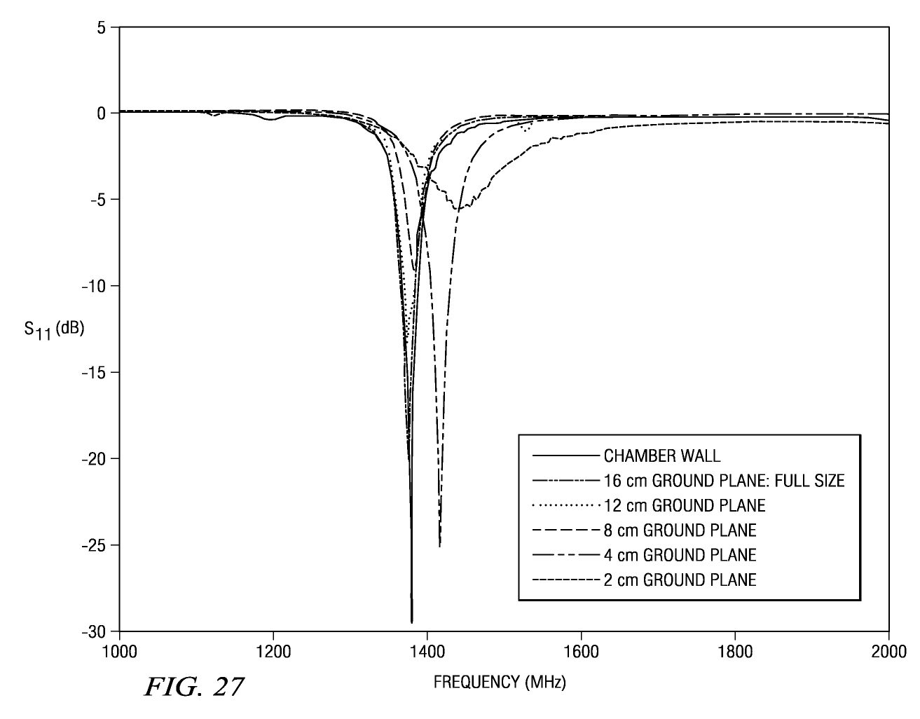

FIG. 27 shows how the finiteness of the ground plane affects the S₁₁ performance of the 2D electric-based EZ antenna. These measurements were achieved by sacrificing one of the original systems and cutting the ground plane to the indicated sizes. It should be noted that the full ground plane size was determined by the restrictions that are imposed by the HFSS software to obtain accurate far-field antenna radiation values, i.e., the radiation box should be sized at least λ₀/4 from the source.

The measured results, which showed very good accepted power values even for a much smaller ground plane, suggest that it would be possible to further reduce the ground plane size and still obtain a high overall efficiency.

### SUMMARY

An EESA design methodology, in which a resonant LC structure is achieved by introducing an appropriately designed electrically-small metamaterial-inspired, e.g., ENG or MNG, element into the extreme near field of a driven electrically-small, e.g., electric or magnetic, antenna, is disclosed. Magnetic-based EZ antenna systems were realized as inexpensive and easy-to-build EESAs. It was demonstrated that they are linearly scalable to a wide range of frequencies and yet maintain their easy-to-build characteristics.

Due to copper losses in the presence of the resulting resonant field distributions, the overall efficiency of these EESAs depended on the choice of the overall electrical size. Even though complete matching was achieved, the versions whose sizes were far from the electrically-small limit were shown to have large conductor losses because of their resonant nature and, hence, had small overall efficiencies.

In contrast, electrically-small-limit versions are shown to be highly efficient. The highly electrically-small versions share this behavior if copper losses are ignored.

In particular, 3D, magnetic-based EZ antenna design details and radiation characteristics at 300 MHz, 1580 MHz, and 6000 MHz are disclosed. Alternative planar designs are also proposed by reducing the 3D, metamaterial-inspired element to a 2D, planar one. In one 2D design, a planar interdigitated CLL element was used; and in a second 2D design, a high-Q lumped element capacitor-based CLL element was used.

The resulting 2D, magnetic-based EZ antennas are shown to be an attractive design due to their electrically-small size, high overall efficiency, and yet easy-to-build characteristics. The lumped element capacitor design introduced a highly desirable potential tuning capability into the 2D, magnetic-based EZ antennas.

Experimental 2D, magnetic-based EZ antennas have been fabricated, and their input reflection coefficients measured. Comparisons of the reflection coefficients obtained from the numerical and experimental results demonstrate very good agreement.

The 3D and 2D, electric-based EZ antennas, which correspond to 3D and 2D, magnetic-based EZ antenna systems, were also considered. The 3D and 2D realizations of these electric-based metamaterial-inspired EESAs were obtained by integrating an effective ENG medium with an electrically small printed monopole antenna fed through a finite ground plane. The 3D version used a 3D, cylindrical, helical, thin copper metal strip as a matching element that is excited by an electrically-small monopole. The 2D version was designed as an electrically-small, printed monopole antenna radiating in the presence of a 2D meander-line.

These 2D and 3D, electric-based EZ antennas are also naturally matched to a 50-Ω source, can be scaled to a wide range of frequencies without any compromise in their performance, and are inexpensive and easy-to-build.

The 3D, electric-based EZ antennas have been shown to have FBW_{VSWR} bandwidths that were larger than their corresponding magnetic-based EZ antenna designs having the same electrical size.

The MTM-inspired EESA design methodology provides an attractive alternative to existing electrically-small antennas. Electric-based EZ antenna systems have been scaled down to the high frequency and very high frequency bands and magnetic-based EZ antenna systems have been scaled up to the millimeter-wave band. In the high frequency bands, for example at 60 GHz, an interdigitated, 2D, magnetic-based EZ antenna system has advantages over existing lumped element capacitor-based matching networks and ESA designs simply because circuit components associated with existing design methodologies are not readily available there.

In contrast, in the low frequency bands, lumped element capacitor versions of the electric-based and magnetic-based EZ antennas can take advantage of readily available small size, large value inductors and capacitors, respectively, to achieve highly sub-wavelength ESA designs.

Although the invention has been described in connection with two- and three-dimensional, electric- and magnetic-based antenna systems, the invention is not to be construed as being limited thereto. Those of ordinary skill in the art will appreciate that variations to and modification of the above-described device, system, and method are possible. Accordingly, the invention should not be viewed as limited except as by the scope and spirit of the appended claims.

What I claim is:

1. An electrically-small antenna system that is matched to a source having a predetermined frequency, the system comprising:
a semi-circular loop antenna that is fed by the source through a finite ground plane via a feedline, the antenna having a diameter, a radius of curvature, and an input impedance; and
an electrically-small, one-unit cell made of a metamaterial that is adapted to match the input impedance of the antenna.

2. The antenna system as recited in claim 1, wherein the antenna system is a resonant radiating system and has a sub-wavelength size.

3. The antenna system as recited in claim 1, wherein the antenna system is a resonant electrically-small magnetic dipole and has a sub-wavelength size.

4. The antenna system as recited in claim 1, wherein the metamaterial-inspired one-unit cell is a self-resonant reactive element that is structured and arranged to resonantly magnify currents induced on the element.

5. The antenna system as recited in claim 1, wherein the metamaterial-inspired one-unit cell is a planar, capacitively loaded loop (CLL) structure that includes a finite perfect electric conductor (PEC) ground plane, the CLL structure being structured and arranged to match reactance and resistive networks in the system to achieve a total input reactance of zero or substantially zero.

6. The antenna system as recited in claim 5, wherein the CLL structure is structured and arranged to include:
an extended surface to provide an effective means for capturing and resonantly magnifying magnetic flux generated by the loop antenna.

7. The antenna system as recited in claim 5, wherein the CLL structure is a three-dimensional, magnetic-based structure that includes:
a first sheet, having a first capacitor leg portion, that is coupled to the finite perfect electrical conductor (PEC) ground plane and
a second sheet, having a second capacitor leg portion, that is coupled to the finite PEC ground plane that is structured and arranged with respect to the first sheet to provide a capacitor gap between the first capacitor leg portion and the second capacitor leg portion.

8. The antenna system as recited in claim 7, wherein the first and second capacitor leg portions are structured and arranged to produce a relatively large capacitance from current stored therebetween of sufficient magnitude to match reactance generated by the loop antenna, to create a resonant current.

9. The antenna system as recited in claim 5, wherein the CLL is a two-dimensional, magnetic-based structure comprising:
a laminate structure having a relatively thick, loss-less dielectric portion on which a relatively thin, planar, electrically-conductive capacitor element is formed, the capacitor element including a plurality of elongate fingers that are interdigitated and that are adapted to provide a tuning capability of a resonant frequency.

10. The antenna system as recited in claim 9, wherein the plurality of elongate fingers are structured and arranged to produce a capacitance that is sufficiently large to match the inductance produced by current flowing along the elongate fingers and current flowing along the ground plane.

11. The antenna system as recited in claim 9, wherein the elongate fingers are manufactured to realize a mu-negative (MNG) metamaterial.

12. The antenna system as recited in claim 5, wherein the CLL is a two-dimensional, magnetic-based structure comprising:
a laminate structure having a relatively thick, loss-less dielectric portion on which a relatively thin, planar, electrically-conductive element is formed, the element having a gap portion in which a lumped element capacitor is disposed.

13. The antenna system as recited in claim 12, wherein the elongated fingers are manufactured to realize an epsilon-negative (ENG) metamaterial.

14. An electrically-small antenna system that is matched to a source having a predetermined frequency, the system comprising:
an electrically-small monopole antenna disposed over a perfect electric conductor ground plane and that is fed by the source; and
an epsilon-negative (ENG) metamaterial that is adapted to match the input impedance of the antenna.

15. The antenna system as recited in claim 14, wherein the ENG metamaterial includes a three-dimensional, relatively-thin, electrically-conductive cylindrical helix wire strip that is excited by the monopole antenna and that is structured and arranged to generate sufficient inductance to match capacitance generated by the monopole antenna.

16. The antenna system as recited in claim 14, wherein the ENG metamaterial is electrically-connected to the ground plane.

17. The antenna system as recited in claim 14, wherein the ENG metamaterial includes a two-dimensional, relatively-thin laminate structure, the laminate structure having a relatively thick, loss-less dielectric portion on which a relatively thin, planar, electrically-conductive monopole antenna and a relatively-thin, planar electrically-conductive meander-line capacitor element are formed.

18. A network for matching reactance and resistance to a source to produce a resonant LC structure, the network comprising:
an electric-based or magnetic-based, electrically-small radiating structure having a near field resonant structure, the radiating structure being fed by the source through a finite ground plane via a feedline and producing a reactance matched by a metamaterial-inspired structure; and
an electrically-small, one-unit cell of a metamaterial that is introduced into the near field of the radiating structure that produces an impedance of sufficient magnitude to match or substantially match the reactance of the radiating structure and the resistance of the source.

19. The network as recited in claim 18, wherein the metamaterial-inspired cell is an epsilon-negative or mu-negative metamaterial.

20. A method of matching reactance resulting from an electric-based or magnetic-based radiating structure placed within a near field of a radiating element, to produce a resonant LC structure, the method comprising:
introducing an electrically-small, one-unit cell made of a metamaterial into the near field of the radiating structure;
adapting the metamaterial-inspired cell to produce an impedance of sufficient magnitude to match or substantially match the reactance of the radiating element and the resistance of the source.
